(19) United States
(12) Patent Application Publication
(10) Pub. No.: US 2023/0393335 A1
(43) Pub. Date: Dec. 7, 2023

(54) PHOTONIC INTEGRATED CIRCUIT DESIGN FOR PLUG-AND-PLAY MEASUREMENT DEVICE INDEPENDENT-QUANTUM KEY DISTRIBUTION (MDI-QKD)

(71) Applicant: General Electric Company, Schenectady, NY (US)

(72) Inventors: William Albert Challener, Glenville, NY (US); Stephen Francis Bush, Niskayuna, NY (US)

(21) Appl. No.: 17/483,968

(22) Filed: Sep. 24, 2021

Related U.S. Application Data
(60) Provisional application No. 63/083,484, filed on Sep. 25, 2020.

(51) Int. Cl. G02B 6/126; G02B 6/125; H04L 9/08

(52) U.S. Cl. CPC G02B 6/126; G02B 6/125; H04L 9/0852

(57) ABSTRACT

A photonic integrated circuit includes a waveguide that receive photons from an optical fiber and directs the photons in a loop formed by the waveguide. The circuit also includes one or more of a variable optical attenuator and configured to adjust a number of the photons between a key level and one or more decoy levels, an intensity modulator coupled with the waveguide and configured to adjust a number of the photons between a key level and a decoy level, and a phase shifter coupled with the waveguide and configured to change a phase of the photons. The waveguide is configured to direct one or more of the photons back out of the optical fiber after the one or more of the photons has passed through the loop formed by the waveguide with a polarization state of the one or more of the photons rotated by 90°.

### CROSS REFERENCE TO RELATED APPLICATIONS

This application claims priority to U.S. Provisional Patent Application No. 63/083,484, filed on Sep. 25, 2020, which is hereby incorporated by reference in its entirety.

### GOVERNMENT LICENSE RIGHTS

This invention was made with government support under contract DE-OE0000894 awarded by the United States Department of Energy. The government has certain rights in the invention.

### FIELD

Embodiments of the present disclosure generally relate to secure communication and/or communication networks, such as use of quantum keys to encrypt communications and/or time-sensitive networks (TSN).

### BACKGROUND

Quantum key distribution (QKD) currently is being investigated for its theoretical ability to distribute random keys between parties for encrypting messages, while simultaneously ensuring that no other party is able to eavesdrop in an undetected way on the key distribution channel. The technique makes use of certain properties of quantum mechanics that prevent a third-party observer from interacting with a system in certain ways without affecting the communication system or network in measurable ways. Time-sensitive networks (TSN) may be required for communication that must be delivered at a specific time, high priority messages, etc. Low priority messages, on the other hand, can be buffered and passed on a best-effort basis, with no timing and delivery guarantees.

One example of a system in which a TSN may be used is a power grid communication network where there are communication network paths that connect devices and may include redundant pathways. Multiple edge devices at various nodes may be included, such as at step-down transformer stations or solar generation stations. These edge devices can be used to monitor temperatures, pressures, or various processes, and which may also require secure communication channels. The nodes typically have substantial infrastructure able to support more complex and expensive instrumentation. In particular, to support high-speed and long-distance QKD communication, cryogenically cooled single-photon detectors preferably may be used. These detectors require substantial electrical power, water cooling, and routine maintenance, and are very expensive (e.g., on the order of $100,000 for a pair of the detectors). As such, these detectors typically may only be placed at a few locations in the communication network. On the other hand, there are many more (e.g., an estimated 400,000) end and edge devices on the power grid, not including solar installations, which can add around another 1.6 million devices.

Enabling encrypted communication among all these devices via QKD necessitates a much lower-cost solution. Furthermore, many of these edge devices may be monitoring and/or controlling critical processes that require TSN. Communications with devices may need to occur at specific times, or if a process monitor finds a problem or failure, the monitor must be able to issue a time-critical alert. At the same time, these monitors or controls must not be spoofed or hacked by some malevolent adversary intent on bringing down the power grid. Therefore, combining QKD with TSN in a manner that enables low-cost, chip-based solutions at the edge devices is needed.

### BRIEF DESCRIPTION

A photonic integrated circuit includes a waveguide configured to receive photons from an optical fiber and direct the photons in a loop formed by the waveguide. The circuit also includes one or more of a variable optical attenuator coupled with the waveguide and configured to adjust a number of the photons between a key level and one or more decoy levels, an intensity modulator coupled with the waveguide and configured to adjust a number of the photons between a key level and a decoy level, and a phase shifter coupled with the waveguide and configured to change a phase of the photons. The waveguide is configured to direct one or more of the photons back out of the optical fiber after the one or more of the photons has passed through the loop formed by the waveguide with a polarization state of the one or more of the photons rotated by 90°.

A method of assembling a photonic integrated circuit includes forming a waveguide configured to receive photons from an optical fiber and direct the photons in a loop formed by the waveguide, and coupling, to the waveguide, one or more of a variable optical attenuator configured to adjust a number of the photons between a key level and one or more decoy levels, an intensity modulator configured to adjust a number of the photons between a key level and a decoy level, or a phase shifter configured to change a phase of the photons, wherein the waveguide is configured to direct one or more of the photons back out of the optical fiber after the one or more of the photons has passed through the loop formed by the waveguide with a polarization state of the one or more of the photons rotated by 90°.

### BRIEF DESCRIPTION OF THE DRAWINGS

The subject matter described herein will be better understood from reading the following description of non-limiting embodiments, with reference to the attached drawings, wherein below:

FIG. 1 illustrates one example of a plug-and-play differential phase shift QKD system;

FIG. 2 illustrates one embodiment of a plug-and-play differential phase shift QKD system;

FIG. 3 illustrates one example of a PIC;

FIG. 4 illustrates one example of a TSN;

FIG. 5 illustrates a notional example of grid communication architecture with integrated QKD hardware;

FIG. 6 illustrates a hybrid QKD star network for the power grid communication in which QKD photonic chips are located at edge/end devices (magenta triangles) for short distance communications with central orange nodes which may be sub stations;

FIG. 7 illustrates attenuation of fiber as a function of wavelength;

FIG. 8 illustrates a central node that generates individual QKD keys with each edge device over the quantum channels;

FIG. 9 illustrates nodes that can generate keys between any two devices with which they are connected;

FIG. 10 illustrates that, as the wavelength difference between Alice and Bob is varied, the interference fringe visibility due to interference of the photons in the X-basis (entangled between the two different time-bins) decreases;

FIG. 11 illustrates an experimental setup;

FIGS. 12A and 12B illustrate an experimental setup of polarization encoding MDI-QKD and a schematic of the polarization modulator, respectively;

FIG. 13 illustrates a conventional Bell state measurement apparatus;

FIG. 14 illustrates a measurement device independent QKD system (MDI-QKD);

FIG. 15 illustrates a modified Bell state measurement apparatus;

FIG. 16 illustrates a plug-and-play MDI-QKD protocol;

FIG. 17 illustrates a proposed setup for P&P MDI-QKD using time-bin/phase encoding; encoding;

FIG. 18 illustrates a P&P MDI-QKD system design using time-bin phase

FIG. 19 illustrates a star network design used to illustrate locations for Charlie nodes;

FIG. 20 illustrates a modified plug-and-play MDI-QKD arrangement that enables a separate router node, M₁, between Charlie and Alice and Bob by using polarization controllers to adjust for fiber birefringence between Charlie and Douglas;

FIG. 21 illustrates a modified plug-and-play MDI-QKD arrangement that enables a separate router node, M₁, between Charlie and Alice and Bob by making use of polarization orthogonality and PM fiber;

FIG. 22 illustrates a MDI-QKD, plug-and-play design where Charlie generates the short time delay between pulses for Alice and Bob and then delays Alice's (or Bob's) pulse stream by a long enough time that all of Bob's (or Alice's) pulses are sent first, followed by the other pulse stream;

FIG. 23 illustrates a “brute force” plug-and-play MDI-QKD arrangement incorporating two separate fiber pathways between Charlie and Douglas;

FIG. 24 illustrates a TS-QKD network diagram;

FIG. 25 illustrates a timing diagram;

FIG. 26 illustrates a calculated key rate comparison between SNSPDs and InGaAs SPADs at 1550 nm for the parameters in Table 6;

FIG. 27 illustrates a design of random number generator for a PIC chip;

FIG. 28 illustrates a technique to enable Alice and Bob to communicate with each other using a laser beam generated by Charlie; and

FIG. 29 illustrates a technique to enable Alice and Bob to communicate with each other lasers at their locations, perhaps on chip, with wavelength division multiplexing.

### DETAILED DESCRIPTION

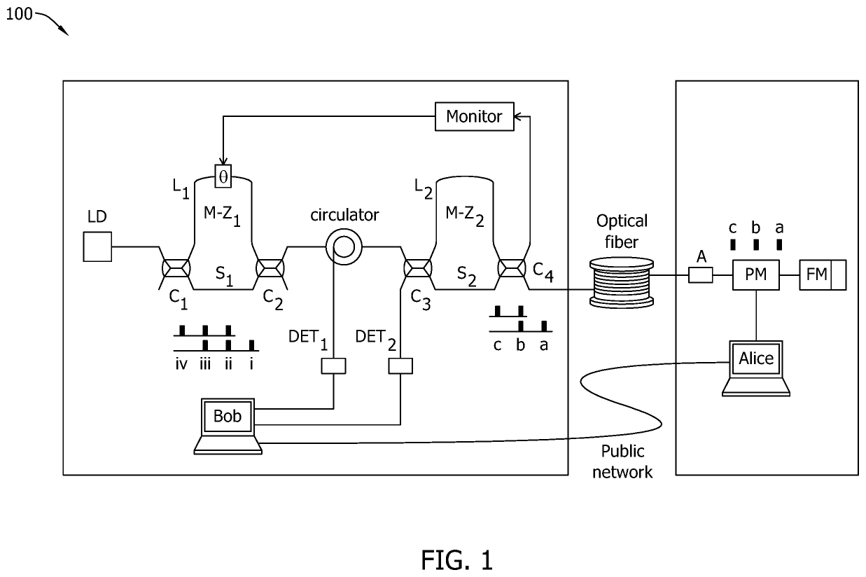

FIG. 1 illustrates one example of a plug-and-play differential phase shift QKD system 100. The QKD system 100 includes at least two communicating devices “Alice” and “Bob” in FIG. 1. Alice and Bob can represent computing devices, such as edge devices, sensors, controllers, etc. Alice and Bob can represent hardware circuitry that includes and/or is connected with one or more processors (e.g., microprocessors, integrated circuits, field programmable gate arrays, etc.) that communicate with each other, such as over a communication network. The communication network may be partially or entirely formed of a public network (e.g., the Internet), one or more private networks (e.g., local area networks), etc., which can be formed of wired (including optical fiber) and/or wireless connections. The network may represent many nodes (e.g., other devices, nodes, switches, routers, etc.) connected with each other by the wired and/or wireless connections.

Alice and Bob may attempt to establish a secure communication channel between Alice and Bob via the network for secure communication of signals. A third-party computing device (referred to as “Eve” and may be similar or identical to Alice and Bob except under the control and/or direction of a third party) may be trying to eavesdrop on the channel between Alice and Bob. Another computing device (referred to as “Charlie”) also may be part of the communication channel between Alice and Bob but is not necessarily a trusted part of the channel. Alice and Bob may each be separately communicatively coupled with Charlie via optical fibers. For example, Alice may not be disposed along the optical fiber(s) between Bob and Charlie, and Bob may not be disposed along the optical fiber(s) between Alice and Charlie.

Plug-and-play in a QKD approach can allow for the components required at either Alice and/or Bob to be relatively inexpensive compared to currently known components. In particular, plug-and-play can eliminate the need for light detectors and light sources at one end of the channel by placing the detectors and light sources at Charlie's node in between Alice and Bob. If Alice and Bob are edge devices, then Charlie can be an untrusted central node connected to many edge devices.

In this design, Bob generates light pulses and sends the light pulses through Mach-Zehnder interferometers (M-Z₁ and M-Z₂). As a result, there are three output pulses. One pulse propagates through both short arms of the interferometer, one pulse through both long arms, and a third pulse which propagates through either of the two short-long arm paths. A phase of shift of 2π/3 in the long arm of one interferometer ensures that when these two photon paths recombine and interfere, the resulting photon amplitude is equal to that of the other two pulses. Alice attenuates the pulses to less than a single photon level on average and applies a random phase shift of π/3 or 4π/3 to the first pulse, and 0 or π to the third pulse. No phase shift is applied to the second pulse. On the return path at Bob, the arm lengths of M-Z₂ are chosen so that the second pulse traveling through the short arm of the interferometer interferes with the first pulse traveling through the long arm. Similarly, the third pulse traveling through the short arm interferes with the second pulse traveling through the long arm. As a result, only four pulses emerge on the return path from M-Z₂. The pulses are then shunted into two detectors before reaching M-Z₁. Due to the phase shifts applied to the pulses, the two center pulses will split between detectors 1 and 2 (DET₁ and DET₂) at Bob. Bob knows which detector has measured a photon, while Alice knows which random phase shifts were applied by Alice and so Alice can predict or otherwise determine which of Bob's detectors will respond for each pulse. In this way, a random key can be exchanged between Alice and Bob without Alice needing detectors or light sources.

This design may be able to be integrated into a computer chip for Alice, but not for Bob because the interferometers which require lengths of fiber in the short and long arms of the interferometers are at Bob's end. Alice has a Faraday rotator to eliminate effects of birefringence in the fiber channel, but this can be accomplished on-chip without need for a Faraday reflector as described below. However, the system design at Bob's end is complex. The two interferometers must be tightly matched, which means extremely good temperature control of the fiber arms as well as feedback systems to constantly maintain the interferometer arm lengths.

Another QKD technique combines both the measurement device independence and the plug-and-play benefit. But, for MDI-QKD to work, the photons prepared by Alice and Bob may need to be identical in time, wavelength, and polarization when the photons reach a non-polarizing beam splitter (NPBS) of Charlie. In practice, this is challenging and may not be easily implemented within a photonic integrated circuit or chip (PIC). Sometimes lasers are frequency-locked using gas cells. Other times, distributed feedback (DFB) lasers are continuously adjusted with temperature controllers. Drifts in photon polarization and arrival times also may need to be continuously monitored and actively controlled with instruments that are usually large and expensive. Over long lengths (e.g., twenty kilometers (km) or longer) of fiber, the travel time of an optical pulse can drift by up to thirty nanoseconds (ns).

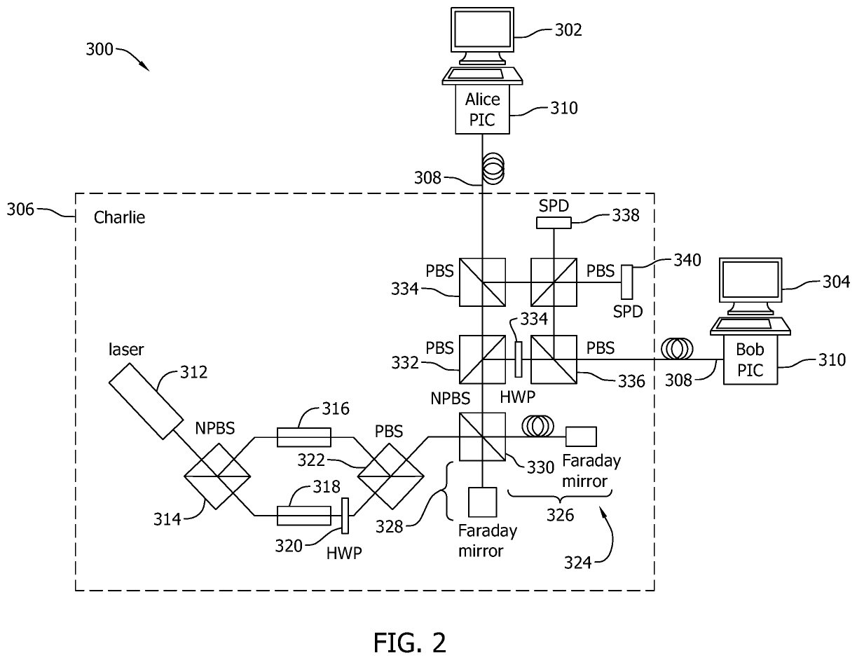

FIG. 2 illustrates one embodiment of a plug-and-play differential phase shift QKD system 300. The system 300 includes the Alice device 302 and the Bob device 304 (described above), which are optically coupled with the Charlie device 306 (also described above) by optical fibers 308. Each of Alice and Bob has a photonic integrated circuit (PIC) 310.

With respect to Charlie, that computing device includes a light source 312 (e.g., a laser) that emits a polarized (e.g., vertically polarized) laser light beam (e.g., into an internal optical fiber and/or waveguide of Charlie). A non-polarizing beam splitter (NPBS) 314 of Charlie can be a 50:50 beam splitter that splits the output of the light source 312 into two beams of equal or approximately equal intensity (e.g., intensities within 1% of each other) that can be independently modulated by separate intensity modulators 316, 318 of Charlie. For example, the modulators 316, 318 can separately modulate the beams into three ns pulses at one megahertz (MHz) (or pulses of another duration and/or other frequency) and with variable time delays between the pulses sent to Alice vs. the pulses sent to Bob.

A half waveplate (HWP) 320 in Charlie rotates the polarization state of one beam (e.g., the beam exiting the modulator 318) to be orthogonal to the other beam (e.g., the beam exiting the modulator 316). These two beams are then recombined by a polarizing beam splitter (PBS) 322. The recombined beams then enter an asymmetric Michelson interferometer 324 having one arm 326 that is much longer than the other arm 328 of the interferometer 324.

A NPBS 330 evenly splits the recombined beams into the two arms of the interferometer 324. The lengths of the arms 326, 328 can be adjusted to return the pulses so that the pulses are separated in time by a designated or fixed time period (e.g., one hundred ns or another time period). Using a free space Michelson interferometer 324 with polarization multiplexing instead of a Mach-Zehnder interferometer with a fiber delay as in one or more other designs allows for the time separation between the pulses to be identical and relatively unaffected by thermal drifts. A PBS 332 then re-splits the two polarizations of the recombined beam and sends one pulse train to Alice and the other to Bob. Another HWP 334 is inserted in the beam sent toward Bob so that the polarization state of the pulse train sent to Bob is identical to the pulse train sent to Alice. This can ensure that the beam passes through another PBS 336 and into the fiber cable 308 toward Bob.

Encoding of the pulse stream by Alice and Bob is handled by intensity and phase modulators of the PICs 310 of Alice and Bob, as described below. The intensity modulators only affect the return pulses and are used to randomly select or block either the first or second pulse. The phase modulators randomly adjust the phase of each pulse to be 0 or π. These are the two bases (time-bin and phase) used for encoding. The PICs 310 of Alice and Bob have a variable attenuator that can ensure the return pulses have on average a fraction of a photon except for decoy states.

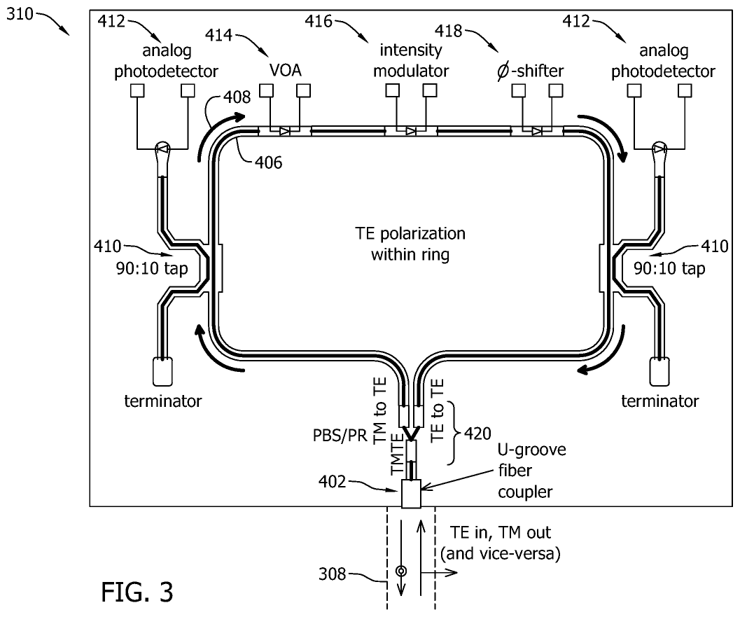

FIG. 3 illustrates one example of a PIC 310. The PIC 310 can be a plug-and-play device at each of Alice and Bob. One advantage to use of the PIC 310 is that it does not require a light source or light detectors, thereby greatly reducing complexity and cost of the PIC 310. Moreover, the Faraday mirror in the systems described above may be essential to the performance of the systems, but the Faraday mirrors are not included in the PIC 310, as described herein. The central node, Charlie, that is connected to all edge devices, does not need to be trusted so that Charlie could be located at control centers and/or stations. The central node that is connected to multiple edge devices can then be used to enable key generation between any two edge devices (e.g., Alice and Bob), and those devices can then communicate via a classical channel through Charlie. In other words, a single fiber from Charlie to each edge device is sufficient to enable encrypted communication between any two edge devices.

While only the photonic components of the PIC 310 are shown in FIG. 3, other components of the PIC 310 may be included. These other components can include circuitry and/or processors generating random signals, controlling the optical components shown in FIG. 3, and computing the key also could be included in the PIC 310 or the system 300 that includes the PIC 310 at each Alice and each Bob. Although not shown in FIG. 3, the PIC 310 also may include a narrow band optical filter either at an entrance waveguide 402 on the PIC 310 or at an end of the optical fiber 308 that connects to the PIC 310. This filter can allow only the correct light wavelength to interact with the PIC 310 to protect against Trojan horse attacks from Eve at other wavelengths that attempt to monitor the phase state of a phase shifter 418 of the PIC 310, for example.

The PIC 310 includes a waveguide 406 (e.g., an internal optical fiber) that forms a raceway or loop in or on the PIC 310. The waveguide 406 is coupled with the external fiber 308 by a polarizing beamsplitter/polarization rotator (PBS/PR) 420. Arrows 408 in FIG. 3 indicate the light path along which a vertically polarized photon received into the PIC 310 from the fiber 308 which enters the chip with transverse-magnetic (TM) polarization which gets converted to transverse-electric (TE) polarization by the polarization rotator (e.g., following a clockwise path around the PIC 310 in the embodiment shown in FIG. 3). The PIC 310 includes light taps 410 optically coupled with the waveguide 406 on opposite sides of the loop or path defined by the waveguide 406. In the illustrated embodiment, the taps 410 are 90:10 optical taps, but optionally may be another type of tap.

The photon received into the waveguide 406 in the PIC 310 from the beamsplitter 402 may have a horizontal polarization. The photon encounters one of the taps 410 (e.g., the tap 410 on the left side of the PIC 310 in FIG. 3). The tap 410 that first receives the photon directs some of the incident light to a photodetector 412. This photodetector 412 may be an analog germanium photodetector or another type of photodetector. The photodetector 412 senses the intensity of the tapped portion of the light for bright light attacks. The rest of the light (that is not diverted by the tap 412) continues around the loop formed by the waveguide 406, and through a variable optical attenuator 414 (“VOA” in FIG. 3).

The VOA 414 reduces the light level (e.g., the brightness, intensity, or the like) so that, during key generation, the PIC 310 is unlikely to emit more than one photon. The light is then received by an intensity modulator 416 that adjusts the average number of photons between a key level and decoy level(s). A phase shifter 418 (“φ-shifter” in FIG. 3) that randomly modulates the phase of the photon (e.g., by either 0 or π). The photon returns to the polarizing beamsplitter 420. A photon following a clockwise path around the loop is transmitted by the polarizing beamsplitter back into the fiber from its TE-polarized state. A photon which follows a counter-clockwise path around the loop is converted by the polarization rotator to TM polarization before entering the polarizing beamsplitter and being passed on to the fiber. Therefore, in either case of photon circulation around the loop, it returns to the fiber with the opposite (orthogonal) polarization state. A TE polarized photon entering the PIC exits back into the fiber as TM polarized, and vice versa, and is then, out-coupled into the fiber 308. As a result, regardless of input polarization, the output photon receives the same phase shift and attenuation but exits the PIC 310 in the orthogonal polarization. This can have the same effect as a Faraday rotator.

Because of the polarizing beamsplitter/polarization rotator 420 combination at the entrance of the PIC 310, the returning photon has had its x/y polarization components interchanged as occurs in a Faraday mirror so that, after the photon returns to Charlie through the fiber cable 308, the effect of birefringence is eliminated. When the photon reaches Charlie (as shown in FIG. 2), a PBS 336 redirects the photon to the Bell state measurement detectors 338, 340 because the polarization has been rotated by 90°.

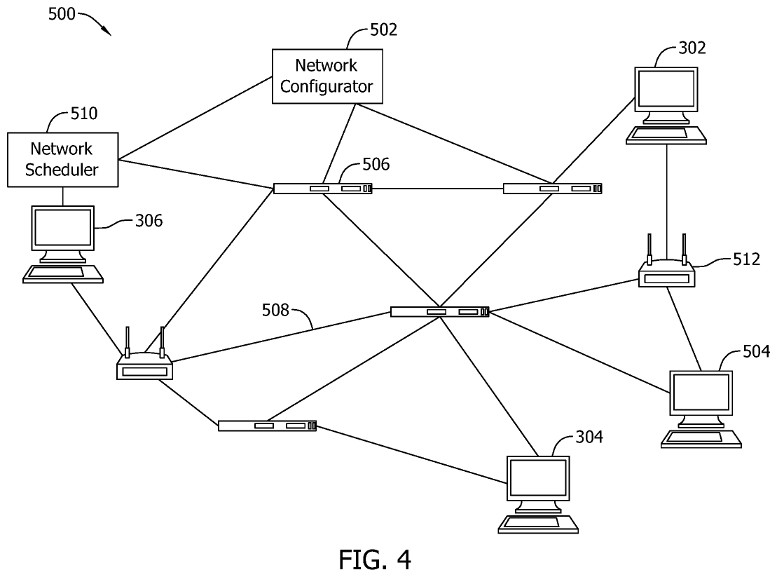

In one embodiment, a communication network that includes Alice, Bob, Charlie, and other nodes can be integrated with TSN. FIG. 4 illustrates one example of a TSN 500. The TSN 500 is a computerized, Ethernet-based communication network that is established according to at least some of the standards developed by the Time-Sensitive Networking Task Group, which may include or otherwise comply with one or more of the IEEE 802.1 standards. In contrast to an Ethernet network operating without TSN that communicates data frames or packets in a random manner, a TSN 500 may communicate data frames or packets according to a type or category of the data or information being communicated. This can ensure that the data is communicated within designated time periods or at designated times. In other Ethernet networks, some data may not reach devices in sufficient time for the devices to operate using the data. The TSN 500 can dictate when certain data communications occur to ensure that certain data frames or packets are communicated within designated time periods or at designated times. Data transmissions within the TSN 500 can be based on times or time slots in which the devices communicate being scheduled for at least some of the devices. The communications between or among some of the devices may be time sensitive communications or include time sensitive data. Time sensitive communications involve the communication of time sensitive data within designated periods of time. Other non-time sensitive communications may be communications that do not necessarily need to be communicated within a designated period of time. These non-time sensitive communications may be best effort communications or rate constrained communications.

Best effort communications may be communicated within the TSN 500 when there is sufficient bandwidth in the TSN 500 to allow for the communications to be successfully completed without decreasing the available bandwidth in the TSN 500 below a bandwidth threshold needed for the communication of time sensitive communications between devices. The communication of best effort communications may be delayed, ensuring that the time sensitive communications are not delayed. Rate constrained communications are communications that are communicated using the remaining amount of bandwidth, if any, in the network. For example, a rate constrained communication may be sent between devices using the bandwidth in the network that is not used by the time sensitive communications and the best effort communications. If no bandwidth is available (e.g., the time sensitive and best effort communications consume all the available bandwidth), then the rate constrained communication may not occur until more bandwidth is available.

As previously described, the QKD technique using Charlie 306, Alice 302, and Bob 304 places the expensive, power hungry equipment (including the light source and detectors) at Charlie, which may be an untrusted node. This node may be connected to multiple edge devices or a control center that is connected to multiple stations. Ideally there are very few of the Charlie nodes on the network due to the complexity, expense, and required routine maintenance for these types of nodes. The approach described above in connection with the system 300 can solve the problem of laser wavelength control. The laser source can be a low-cost DFB laser diode which is temperature controlled to maintain a fixed wavelength over the time interval corresponding to the difference in arrival times of the photons from Alice and Bob. For example, if the optical fiber length from Charlie to Alice is ten km longer than the length of the optical fiber from Charlie to Bob, this corresponds to a time difference for photon travel of around fifty microseconds, or a round-trip time difference of one hundred microseconds.

So long as Charlie's laser temperature and wavelength remains sufficiently constant over this very short time interval to within the bandwidth of the laser line, the photons from Alice and Bob will be indistinguishable in wavelength after returning to Charlie. By using Faraday mirrors and a time-bin/phase encoding technique, the distinguishability between the two photons from the polarization effects of the fiber birefringence can be eliminated. The only remaining issue is a requirement that the photons from Alice and Bob photon return to the NPBS 330 of Charlie at the same instant. Stated differently, the photon wavefunctions from Alice and Bob must overlap when they arrive at the beamsplitter 330.

A network configurator (NC) 502, or alternatively, centralized network configurator (CNC), manages and controls the entire network. The CNC can have complete information about network topology. Topology information can be manually entered or devices on the network 500 (end-systems 302, 304, 504, switches 506, and/or routers 512) can report information about the immediately adjacent connections (neighbors), thereby enabling the entire interconnectivity of the network 500 to be discovered by the CNC 502. This includes both classical (e.g., Ethernet or wireless) devices and connections as well as quantum optical devices and connections. For example, communication links 508 shown in FIG. 4 can represent electromagnetic wireless connections, conductive wired connections, optical fibers, or a combination thereof.

The CNC can use QKD-generated keys to authenticate and encrypt communication with devices in or on the network. For the classical control plane (e.g., communication via wired and/or electromagnetic wireless communications), the maximum size of every message is known, a priori, by the CNC, where message size is used to compute message transmission time. For the quantum data plane (e.g., communications using transmission of light via or along optical fibers), a single-photon message size can be the duration of time between the request for transmission of a single photon and the time the photon is actually emitted by the device. For a classical system, this can be known with a high degree of determinism, but for a quantum system, a Poisson mean value may be the most that can be determined.

The propagation delay along every link 508 may be known a priori, inferred either via cable length or via a variety of means that involve echoing a small message from adjacent neighbors 302, 304, 306, 504, 506. The CNC can query optical components within the network 500 for the single-photon propagation delay of quantum fiber channels 508.

A separate time synchronization protocol, for example, one of the many profiles (variants) of Precision Time Protocol (PTP), known as gPTP, maintains clock synchronization throughout the network 508. This can be accomplished by ensuring network interfaces support hardware timestamping, enabling accurate and precise timestamps that are placed in short messages exchanged to measure link delay. Timestamping is done within the hardware as close to the “wire”, e.g. the physical link, as possible to ensure no jitter or delay occurs from anything other than propagation time over the link. Typically, messages are sent and returned with appropriate timestamps allowing the device 302, 304, 306, 504, 506 initiating the propagation delay measurement to divide by two assuming the link is symmetric. Propagation delay measurements can be periodically performed to ensure up-to-date results.

Once link propagation delays are known, synchronization messages are exchanged between devices 302, 304, 306, 504, 506 that contain the current clock tick rate. The devices 302, 304, 306, 504, 506 may include or be connected with separate clocks, with one of the clocks identified or selected (e.g., by the NC 502) as a grandmaster clock and all other clocks adjust their tick rate ratio such that the time of the other clocks matches the notion of time of the grandmaster clock. Since clocks are clearly defined relative to one another in a master-slave relationship forming a spanning tree, clock rates are adjusted relative to one another such that all clocks match the grandmaster clock. Stated differently, grandmaster time can be reconstructed by every clock in the network 508. There may be some error, however small, typically measured in root mean square (RMS) nanoseconds. This error can be dependent upon the stability of the clocks, how often the synchronization messages are sent, and in a large network 508, on placement or selection of the grandmaster clock within the network topology relative to the other clocks.

All of the PTP message exchanges can be authenticated and encrypted using QKD-generated keys, as described above. The network 508 is time synchronized, and the CNC 502 knows message sizes, the network topology, and link propagation delays. The CNC 502 also knows the source and destination of messages in the network, including classical control messages and quantum data plane messages. If the CNC 502 is provided with maximum-tolerated latencies for each pair of end-systems that need to communicate (e.g., the devices 302, 304, 306, 504), the CNC 502 can determine a single-photon path and schedule when each device (e.g., nodes 506, which can represent switches) along the path should transmit the photon. The CNC 502 can compute initial transmission (photon emission) and periodic opening and closing times of gates (the switches 506) for each device 302, 304, 306, 504 along a network path (e.g., the links and switches between and interconnecting communicating devices) such that messages are sent and received at precise, periodic intervals forming a connected path while simultaneously avoiding collision within the network 500. Collision occurs when transmitting more than one message at the same time (such that the photons, in this case, would overlap) over the same link 508.

However, as described above, there are quantum networking algorithms where the goal is to create a perfect collision, namely a simultaneous event where two messages (single photons) arrive at the same location at the same time. And the goal is to accomplish this simultaneous event periodically. Although this is something a network scheduler 510 typically seeks to avoid, it is an interesting task to add to the capabilities of the scheduler 510. The scheduler 510 can represent a computing device that schedules when different switches 506 are open, when different devices 302, 304, 306, 504 communicate in the network 500, and the like.

In a classical setting, the CNC 502 attempts to meet or exceed the required minimum latencies for each deterministic flow of data. This can be tightened to provide exact latencies. Also note, that in a strictly classical Ethernet setting, the CNC 502 can control the flow of a classical data plane. However, the control plane can remain classical, while the data plane is quantum. The CNC 502 can send configuration information to configure known, deterministic paths through the quantum data plane at precisely periodic time intervals. Typically, this would be done via a YANG module that exposes network configuration and control information about a device. The CNC 502 can either be provided with the required quantum channel paths or be able to query and learn about the quantum network via NETCONG/YANG or Link Layer Discovery Protocol (LLDP), and infer when specific quantum channel paths are required. For example, if the CNC 502 were provided with the fact that certain network devices 302, 304, 306 identified themselves as Alice, Bob, or Charlie, and the duration of time connections are required among Alice, Bob, and Charlie, then the CNC 502 can compute and configure such connectivity for the entire network 500. The CNC 502 can decide as to which Alice, Bob, and Charlie combinations are optimal for the network 500, depending upon the locations, capabilities, and QKD key consumption requirements within the network 500.

Since the network is time synchronized, the CNC 502 also can provide meaningful information about whether, and precisely when, a coincidence event happened at Charlie to Alice and Bob, and can provide additional support and verification of events needed for MDI-QKD. There exist numerous scheduling algorithms that can be used by the CNC 502. We anticipate the CNC becoming a quantum algorithm running on a quantum computer within the quantum network.

If Alice and Bob are edge devices that are part of a TSN 500, then the node (e.g. Alice, Bob, or Charlie) includes a network clock. Each network output port has a clock in TSN 500 to control the gates. The clocks on the devices can be synced to network time (e.g., the grandmaster clock). A QKD chip can use this clock for timing. Alice and Bob can use timing, for example, to modulate the pulses from Charlie, determining which pulses to shutter or pass, which pulses to phase shift or not phase shift, and which pulses are decoy states that have a different average number of photons.

Another interesting difference between classical use of the CNC 502 and the inventive subject matter described herein is that classically, the CNC 502 computes a single cycle time with offsets indicating when each network event occurs, and this cycle time and these offsets remain constant over many cycles. In one embodiment of the inventive subject matter, however, propagation delays may need to be updated more often due to sensitivity of fiber length on propagation delay. It is recognized that re-computation may only be done when propagation delay changes are significant enough to warrant a re-computation. This could be determined, for example, by a noticeable drop in the key production rate. It should also be noted that the CNC 502 can now control events such as coincidence detection windows and photon detector gating as well as network switches 506 and classical Qbv gate control.

The CNC 502 can direct Charlie when to send an initial calibration pulse to both Alice and Bob and configure the network switches 506 such that the pulse travels to Alice and Bob and back to Charlie so that Charlie can then determine the correct time delay, report the time delay back to the CNC 502, and the CNC 502 can tell Charlie again when to send the QKD pulse sequence to Alice and when to send the QKD pulse sequence to Bob, while ensuring that the appropriate network paths are selected.

Alternatively, if Alice's, Bob's, and Charlie's clocks are synchronized, then Alice and Bob only need to timestamp when each received Charlie's pulse, and report the timestamps to the CNC 502. Charlie can report when the pulse was sent by Charlie (can report to the CNC 502). The CNC 502 can then tell Charlie when to send the QKD pulses to Alice and Bob and also when to expect the return coincidence from Alice and Bob. Charlie may need to gate the detectors 338, 340 to just look for the return photon coincidences from Alice and Bob within a narrow time window to eliminate dark count noise from the detectors 338, 340.

Since Charlie can be assumed to be untrusted, consideration can be made regarding what capabilities are placed on Charlie. For example, Charlie may be prohibited (e.g., by the CNC 502) from being a grandmaster clock. As another example, Charlie may not be included (by the CNC 502) in the time synchronization and scheduling processes described above, as Alice and Bob (which are trusted nodes) can participate in time synchronization and scheduling without Charlie. However, if Charlie were to attempt to report misleading values, this would fail to create simultaneous events leading to detectable error.

As shown in FIG. 4, the network 500 includes redundant channels. For example, a channel can be a combination of links and/or nodes between communicating devices. There may be several redundant channels between Alice and Bob (and between other combinations of devices). This means that information packets may not have a fixed, a priori route over which the packets travel between two devices. The path can be determined by the network 500, or by the CNC 502. In the TSN 500, there is additional control. For example, not only is the route determined, but the timing of various switches 506 and routers 512 along the path also can be determined by the TSN scheduler 510.

When a regularly scheduled communication is to take place between two devices, the TSN scheduler 510, which may be collocated with Charlie, fixes the route for the communication and directs Charlie to determine the optical time delay between Charlie and Alice, and between Charlie and Bob, by sending a classical (e.g., high intensity, many photon) pulse from the QKD laser of Charlie over the channel along the route. Charlie also can send a several photon pulse during the QKD process described above as well, so this classical pulse may not require modification of the laser pulse intensity of Charlie. The TSN scheduler 510 can direct the appropriate switches 506 are open along the route so that the pulse is not intercepted and buffered at any switch 506. Alice and Bob reflect the pulse back to Charlie along the same route, as described above.

Stated differently, Alice and Bob may not attenuate the pulse from Charlie to single photon levels like Alice and Bob do during the QKD process described above. Alice and Bob may still return the pulse (via Faraday mirrors or the waveguides 406) to reflect the pulse so that time delays from fiber birefringence are also included in exactly the same manner as during the QKD process described above. Charlie still distinguishes between return pulses from Alice and Bob. If the return pulses are polarized identically, as the pulses are for the PICs 310 described above, then Charlie may insert another splitter in the return path for Alice and Bob to detect each return pulse separately. Because the pulses are relatively bright pulses, the splitters may not have to split off much light to separate conventional photodetectors. Alternatively, in schemes in which the return pulses arrive oppositely polarized, because the pulses will arrive at different times, the pulses may be distinguishable and identifiable at the single photon detectors 338, 340. Detecting the pulses with the built-in single photon detectors 338, 340 can automatically include timing delays from the detectors 338, 340. Alice and Bob may still need to attenuate the return pulses so that the return pulses do not saturate the detectors 338, 340. Instead of a single pulse, Bob may also send a pulse sequence to Alice and Bob to provide better timing information from weak return pulses.

Charlie can determine the time difference between detection of the two pulses and can communicate this time difference to the TSN scheduler 510. The TSN scheduler 510 can select the same route and opens the channel for the QKD key distribution to Alice and Bob at the appropriate times (which may be different depending on the time delay required). Charlie now knows the delay that should be used between the photon sent from Charlie to Alice and the photon sent from Charlie to Bob so that the reflected photons arrive at the NPBS 330 at the same instant. When triggered by the TSN scheduler 510, Charlie then can send the sequence of pulses to both Alice and Bob with the appropriate delay. The TSN scheduler 510 can set up this time calibration routine as frequently as required so that the slow drifts in the speed of light over the optical fibers that occur do not affect the quantum key distribution.

The network scheduler 510 can configure QKD data transfer from Alice and Bob over two different quantum channels of different lengths such that the quantum data arrive simultaneously at Charlie. The network scheduler 510 can determine the time delay for data that is sent between Charlie and each of Alice and Bob. While the control plane is classical, the data plane is a separate quantum channel that may need to interoperate with the classical scheduler 510, and requirements for data transfer and synchronization across the separate quantum channels are different than for a classical channel (e.g., in the quantum channel, single photons are being transferred and the photons must be indistinguishable when they arrive at Charlie for Charlie to make a valid measurement; the photons must arrive with the same polarization, same wavelength, and at the same time).

In one embodiment, this can be achieved by Charlie sending a pulse along a specific network path to both Alice and Bob, and report the absolute time (e.g., 22:01:33.846) to the scheduler 510. This time can be when Charlie emitted the pulse. Alice and Bob also can individually report (to the scheduler 510) the absolute time at which each received the respective pulse. Charlie's, Alice's and Bob's clocks can be synchronized to the grandmaster clock with precision so that a time delay between the two round trip pulses through Alice and Bob can be accurately calculated by the scheduler 510. The scheduler can make additional corrections for latency in the electronics of the devices 302, 304, 506, 508, or other factors.

In another embodiment, Charlie can send a pulse along specific network paths to Alice and Bob. Alice and Bob can return the pulse along the same network paths to Charlie without attenuation to low photon levels. Charlie can then determine the elapsed time between sending the pulses and receiving the pulses, and can report the time delay to the scheduler 510 (rather than absolute time). In this case, Charlie could send separate pulses first to Alice and then to Bob to determine their separate propagation times, or Charlie could switch in a photodetector at his node into each fiber connection to Alice and Bob, just send one pulse that is simultaneously split to both Alice and Bob, and then detect the return pulses separately. This approach has the advantage in that absolute timing accuracy is not required. Only Charlie needs to make a time measurement, and he only needs to make a measurement of the time delay between the two return pulses. Again, either Charlie or the scheduler may need to make small corrections to the time delay to account for electronics latency.

The scheduler 510 can provide a network path from one node 506, 512 to two different devices 302, 304, 306, 504 such that light pulses from Charlie are emitted at appropriate times along the two different network paths to Alice and Bob, and then return to Charlie at the same time. In one embodiment, this can occur by adding a constraint to the scheduler 510 that two data flows must arrive at the same destination at the same absolute time. In this case, the flow from Charlie to Alice may be opened at a different time than the flow from Charlie to Bob, even though the network path for the return pulses to Charlie may close at the same time when the data transfer is complete. In another embodiment, a single Alice, Charlie, and Bob flow can be created for the duration required and then divide the flow into Alice-Charlie and Bob-Charlie portions as a separate step.

The network scheduler 510 can determine how to configure a large pool of devices, each identifying as an Alice, Bob, or Charlie throughout the network 500. This could include finding the shortest network path to reduce optical attenuation. The scheduler 510 can communicate with either (a) Charlie or (b) Alice and Bob so that Charlie, or Alice and Bob, can adjust attenuation settings depending on the length and optical losses of the selected network path so that the devices are communicating at the appropriate fractional photon level for the QKD and decoy states.

Alice and Bob can determine when Alice and Bob receive pulses from Charlie to modify those pulses by phase shifting, attenuation, etc. This knowledge can come directly from Charlie with some initial classical communication before subsequent QKD pulses, for example, or the scheduler 510 can communicate with Alice and Bob in a classical manner (e.g., through Charlie). Alice and Bob have built-in clocks synchronized to the grandmaster clock, which can enable Alice and Bob to modulate the pulses from Charlie at the appropriate times once Alice and Bob know when the pulse data stream is arriving. Alice and Bob also can have some type of randomizer for selecting phase shifts, time-bin attenuations, decoy state amplitudes, etc.

After completion of the quantum pulse sequence, Charlie can broadcast the results of Bell state measurements to both Alice and Bob over the classical channel, Alice and Bob can share the random bases they selected for each pulse over the classical channel, and Alice and Bob in turn can compute the error rates and private key(s) (e.g., using processors of Alice and Bob).

The following provides additional information on one or more embodiments of the inventive subject matter described herein.

Three tasks of the Time Sensitive Quantum Key Distribution (TS-QKD) program are focused on chip integration. This document summarizes the results of Task 9, “Identify technologies for implementing integrated QKD chip architectures and filling identified gaps via analysis, simulation, and/or experimentation as appropriate, and architecture.” It builds upon Task 7, “Prepare integrated architectures and identify technology gaps in support of Time-Sensitive QKD supported by analysis, modeling, and experimentation as appropriate” and Task 6, “Develop standard network management QKD data model for configuration and management of Time-Sensitive QKD.”

Chip layouts are shown herein as block diagrams for implementing a QKD system. A chip design suitable for implementation using current technology is proposed for several different network and fiber configurations. This design relies upon and enhances time sensitive networks (TSN) for its operation. A star network approach that maximizes the number of end/edge device connections while minimizing cost through use of chip-level solutions at edge devices is considered in detail.

In this document, we first discuss requirements for the power grid. We explain a hybrid network approach to minimize network cost. Although many different QKD techniques have been developed and discussed in the literature, we focus on measurement device-independent QKD in the third section as an approach in which all the vulnerabilities due to imperfections in detector technology have been eliminated, making this perhaps the most secure practical QKD approach that has been described. Two varieties of MDI-QKD are discussed in detail.

A QKD technique with distinct advantages for integration into photonic integrated circuit (PIC) chips is called “plug-and-play.” We discuss this technique in some detail, followed by a discussion of an approach in which plug-and-play has been successfully integrated with MDI-QKD. The advantages of the combined approach are substantial from both a security standpoint and from a PIC chip implementation standpoint. This section is followed by a QKD network design that minimizes the number of expensive Charlie nodes while enabling PIC chips at all edge devices.

Integrating this proposed chip and network configuration with time-sensitive networks (TSN) is discussed in the next section. It is seen that the QKD chip design and hybrid network design are especially compatible with TSN. In the next section we discuss the actual chip layout for the proposed PIC chip design. This is followed by a short section describing various enhancements to the chip that could ultimately be included along with the components specifically for QKD key transfer such as quantum random number generators. The calculation of the QKD key generation rate follows this section. The calculation for time-bin/phase encoding in the MDI-QKD technique is relatively complex and tedious and is outlined in detail in an appendix. A following section briefly describes the implementation of the chip fabrication. The goals of this task have been fully met with a design for both a chip and a TSN-based QKD network that could be implemented on the power grid.

### 1. Introduction

The goal of Task 9 is to identify technologies for implementing integrated QKD chip architectures and filling identified gaps. A photonic integrated circuit (PIC) chip design that can be fully implemented today to deliver quantum key distribution technology to the power grid in a cost-effective manner is described herein. Furthermore, we describe a network configuration that minimizes the expensive components of the technology and enables quantum encrypted communication between an arbitrary number of edge devices on the power grid. The basic concept makes use of the measurement device-independent technique (MDI-QKD) enhanced by a plug-and-play design. This enables a PIC design in which no light sources or detectors are located at the edge devices but are entirely located at an untrusted node at the center of a star network. This network design is particularly compatible with time-sensitive networks (TSN) as will be discussed in more detail herein.

### 2. QKD Network Configurations For The Power Grid

There are a wide variety of QKD techniques. These techniques are more or less suitable for an integrated photonic chip architecture. It has been estimated that over 200,000 integrated QKD interfaces would be required to fully protect the edge devices on the grid. If limited deployment to end devices is included, the number rises to over 400,000. Including solar installations, the estimated number of required QKD chips is over 2 million. Therefore, to fully protect the power grid by QKD will necessitate a low-cost solution, of which integrated photonic chips will be the only option.

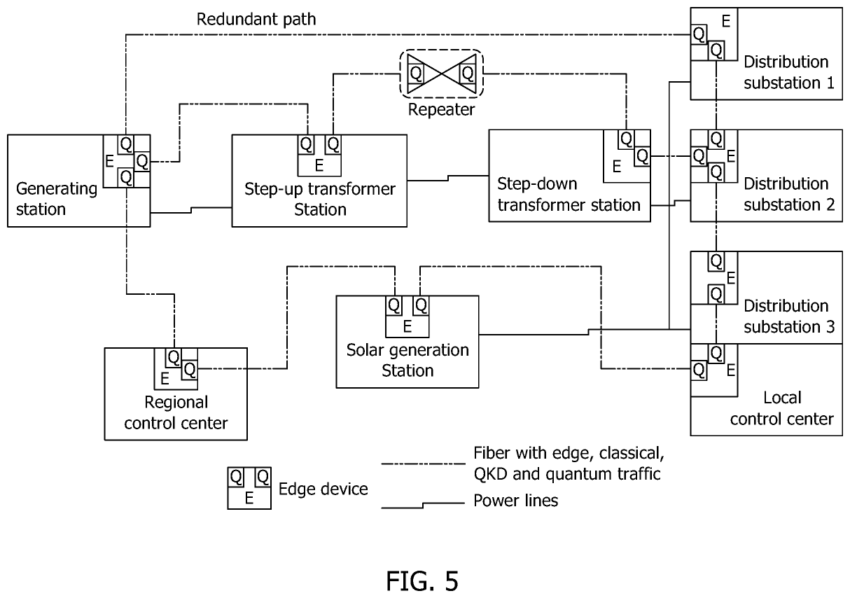

Some of the most important factors that will influence choice of QKD chip design are the distance between communication sites, cost, and required data rates. A generic state-of-the-art grid communication architecture with integrated QKD hardware is shown in FIG. 5. This design assumes that “QKD hardware can be reduced in size (preferably a single chip or multi-chip module) so that it can be integrated directly into each edge device interface. These interfaces are the logical choice since they are already present for each encrypted data link between substations. Furthermore, they are typically connected by fiber, which could also double as the quantum channel via time and/or wavelength division multiplexing.”

It is likely that to protect the entire power grid with QKD, it will be necessary initially, and perhaps for a long period of time, to combine different types of QKD devices on the network (making QKD standards essential). How this can be done is not yet obvious. For example, at a central trusted node, two or more different and separate QKD stations operating under different protocols (BB88, E92, B92, CV, etc.) and/or with different techniques (entangle photons, single photon, polarization, time-bin/phase shift, etc.) may be co-located and physically connected to an intermediate device to transfer keys between the different QKD systems, thereby enabling key-sharing and classical communication between two devices located on different QKD networks. Alternatively, some work is being done that might enable one system to operate under several different QKD protocols.

It is also clear that different network nodes will have different operating requirements. Some devices may employ cryogenically-cooled detectors, for example, and enable long distance and/or high speed QKD across optical fiber for hundreds of kilometers. These devices will inevitably be large and expensive. They in turn will be connected to local nodes, edge devices, or perhaps even end devices via lower cost, more compact systems, perhaps including integrated photonic chips.

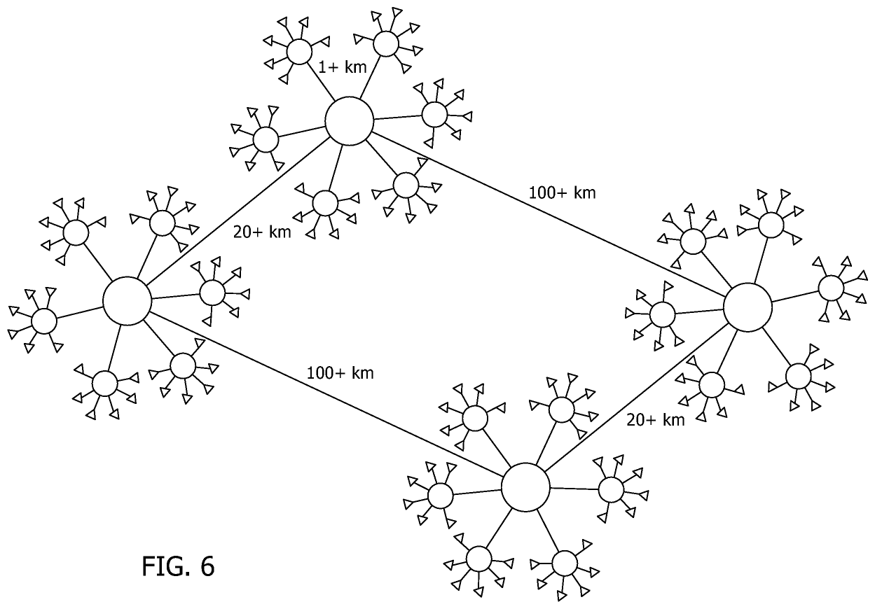

A hybrid network configuration is shown in FIG. 6. In this network design, high speed and/or very long distance QKD encrypted communication takes place along the red pathways between the blue nodes. These may include repeaters as shown in FIG. 5. Initially the repeaters are probably trusted nodes, but eventually the repeaters may be untrusted quantum nodes able to transfer entangled quantum states. The network design in FIG. 6 lends itself to “measurement device-independent” (MDI) architecture. There are some compelling reasons for this approach if QKD is to be implemented on hundreds of thousands of edge devices at the chip-level. In this concept, the blue nodes in FIG. 6 require the latest technology which will most likely require cryogenics (for superconducting nanowire detectors) that are bulky, expensive, and require significant electrical power, water cooling, and annual maintenance. Therefore, the number of blue nodes on the network will be very limited, possibly only one per metropolitan area. Within the metropolitan area, the blue nodes are connected to orange nodes that may be substations, for example. Presumably, there are more orange nodes than blue nodes but many fewer orange nodes than edge devices, so the equipment they contain can potentially be more expensive, require maintenance, etc. than the edge nodes. For example, they may operate with a thermoelectrically-cooled InGaAs single photon avalanche detectors (SPADs) which are still relatively expensive ($20K ea.) but much less expensive than superconducting nanowire detectors and require much less maintenance. As we will describe in this report, the orange nodes may also simply be optical switches that connect any two edge devices to the same blue node. That could significantly reduce the cost of the orange nodes by not requiring QKD equipment at those nodes. This will be discussed in more detail in a subsequent section. The result of this network design, however, is one primary large (expensive) node per metropolitan area connected via switches to all edge devices which employ QKD chips for encryption and that are coordinated and synchronized by a TSN layer. As will be seen, the TSN layer becomes critical for the type of simplified QKD network that is envisioned that employs a “plug-and-play” architecture.

FIG. 6 illustrates a hybrid QKD star network for the power grid communication in which QKD photonic chips are located at edge/end devices (magenta triangles) for short distance communications with central orange nodes which may be substations. Large, more expensive QKD systems employing cryogenic superconducting nanowire detectors, for instance, are located at the blue nodes for communication over 100+ km distances or wherever high speed QKD is required. There may be only one blue node per metropolitan area. Intermediate distances between blue and orange nodes may be connected with QKD systems that employ InGaAs single photon avalanche detectors, which are still not chip-based and are also relatively expensive. Connections to the edge devices, on the other hand, can be made via chip-based QKD.

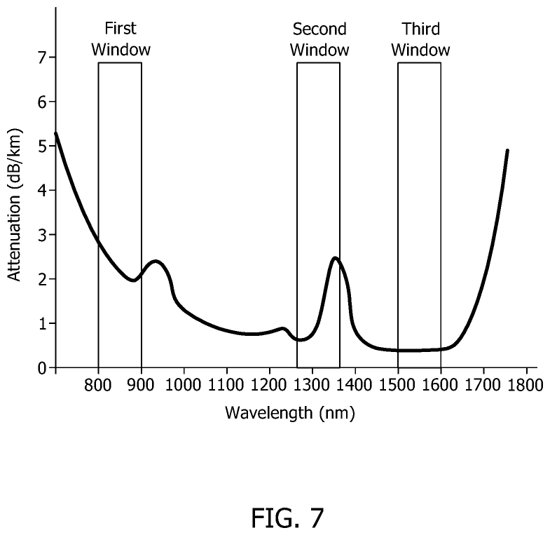

Nodes that are separated by distances up to ˜20 km can potentially be connected without cryogenics, using InGaAs detectors, which are still much too expensive for placement at edge devices. Shorter distance links, on the order of 10 km or less may be capable of handling QKD at a wavelength of 850 nm. As shown in FIG. 7 from https://www.quora.com/Can-optical-fibers-transfer-light-of-any-frequency-or-are-there-any-limitations, fiber attenuation at this wavelength is an order of magnitude larger than that at 1550 nm. However, silicon APDs are available at this wavelength for single photon detection without cryogenics, and these detectors are several times less expensive than InGaAs SPADs. These detectors, however, are nevertheless still too expensive (˜$5K) for edge devices and are incompatible with Si waveguides in PICs.

For PICs to be used at edge devices, there are essentially two options. The simplest approach is to completely eliminate light sources and detectors at the edge devices. This is possible through plug-and-play QKD in which the detectors and light sources are all placed on the central node. In FIG. 6, the light source and detectors would be located on the orange or blue nodes and the triangular edge devices would only have standard PIC components like switches, attenuators, and phase shifters. Such a QKD system has been described in P. Zhang et al., “Reference-frame-independent quantum-key-distribution server with a telecom tether for an on-chip client,” Phys. Rev. Lett. 112 (2014) 130501. A disadvantage of the approach in this reference, however, is that it requires two separate fibers, both of them polarization maintaining (PM) fibers, connecting each edge device to the central node, or four fibers to connect two edge devices together via a central node. As will be subsequently described, this disadvantage can be eliminated so that only a single fiber, of standard single mode rather than PM, is required for connection to each edge device. In fact, for edge devices that can be connected by line-of-sight, it may be possible to implement QKD through free-space connections without the need for fiber.

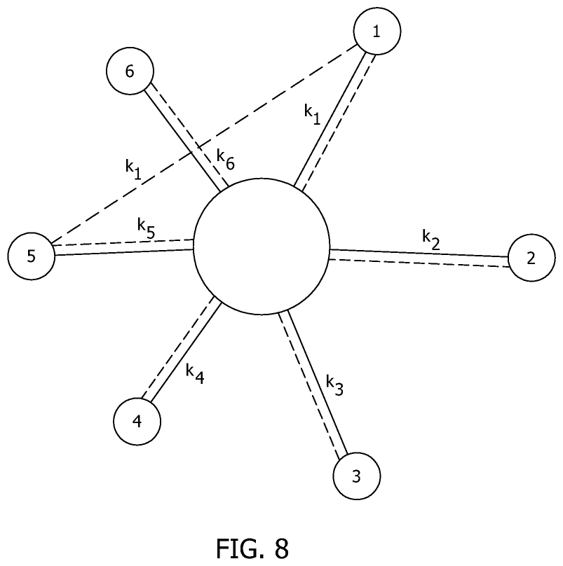

In the Task 7 report it was pointed out that a secure key can be generated between any two nodes connected together via an intermediate trusted node as shown in FIG. 8. If encrypted communication between edge devices 1 and 5 in FIG. 8 is required, for example, then the central node can generate QKD keys k₁ and k₅ as usual, and then use key k₅ to encrypt key k₁ and send that on to edge device 5 over the classical channel. Edge device 5 can now decrypt key k₁ to communicate over a classical channel with edge device 1.

FIG. 8 illustrates a central node that generates individual QKD keys with each edge device over the quantum channels solid lines. The node then can use these keys to provide keys over the classical channel (dashed lines with shorter dashes) for communication between any two edge devices over another classical channel (dashed lines with longer dashes).

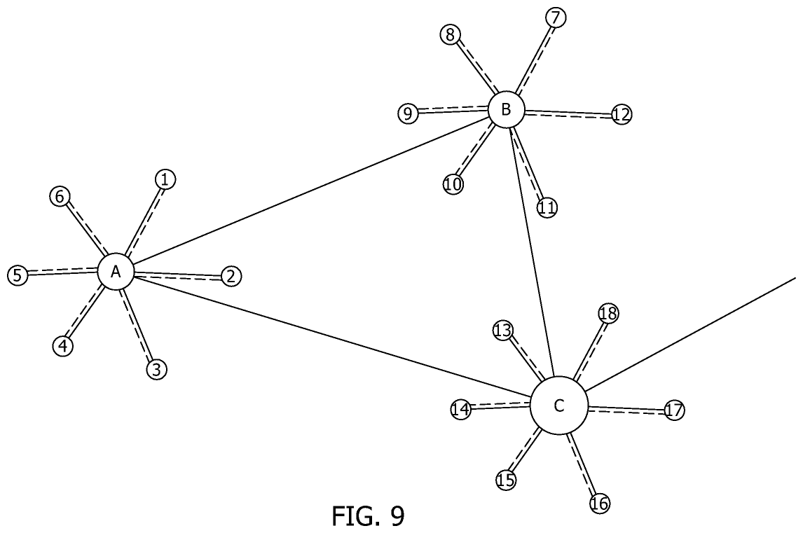

It should be noted that no quantum channel is required between the two edge devices. It is only necessary that they be connected via a classical channel which may even be Wi-Fi. In a star network they are already connected via a central node as shown in FIG. 9, so once a secret key has been generated between any two nodes, all of the classical communication can be encrypted and passed via the node which then acts as a router, or it could also be sent through any other available channel. The node could be used primarily for generating QKD keys between any two of its connected nodes, and all classical traffic could then flow via other classical channels, including a TSN channel.

FIG. 9 illustrates nodes that can generate keys between any two devices with which they are connected. Therefore, keys can be generated between any devices, which then can employ any path, chosen by the TSN scheduler, to communicate classically.

### 3. Measurement Device Independent-QKD (MDI-QKD)

Measurement device independent-QKD (S. L. Braunstein and S. Pirandola, “Side-channel-free quantum key distribution,” Phys. Rev. Lett. 108 (2012) 130502; P. Zhang et al., “Reference-frame-independent quantum-key-distribution server with a telecom tether for an on-chip client,” Phys. Rev. Lett. 112 (2014) 130501) is one of many specific QKD techniques. It has received considerable attention because it eliminates many of the potential side channel attacks related to imperfections in detectors that are among the most difficult to handle. It also can enable longer distance key distribution. In this approach, both Alice and Bob generate separate single photons at the same wavelength and polarization, and send them across fiber to an intermediate station, Charlie, who performs a Bell-state measurement. Charlie announces the results of the measurement to both Alice and Bob over a classical channel. Even if the measurement is performed in an untrusted location by Eve, she is unable to determine the original state of photons sent by Alice and Bob. However, Alice and Bob can generate a key from their knowledge of the random state they each selected and the result of the Bell state measurement. The untrusted node, Charlie, between Alice and Bob can in principle be the blue node in FIG. 8. Then the expensive single-photon detectors only need to be located at Charlie's setup, not Alice's or Bob's.

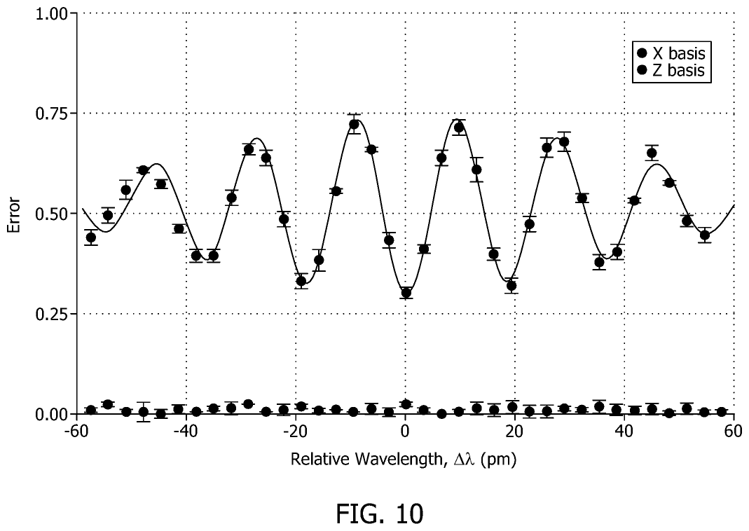

For the photons from Alice and Bob to interfere at Charlie's beamsplitter, they must meet three criteria. They must have the same wavelength, the same polarization, and they must arrive at the same time at the BS. (H-K. Lo, M. Curty and B. Qi, “Measurement-device-independent quantum key distribution,” Phys. Rev. Lett. 108 (2012) 130503 and H. Semenenko, P. Sibson, A. Hart, M. G. Thompson, J. G. Rarity and C. Erven, “Chip-based measurement-device-independent quantum key distribution,” Optica 7 (2020) 238. Wavelength can be stabilized by a feedback circuit using an atomic absorption line to guarantee that photons emitted by both lasers have the same wavelength. A typical DFB telecom laser diode has a linewidth 1-10 MHz. Ultra-narrow linewidth lasers are also commercially available at telecom wavelengths with linewidths <100 Hz. (M. Żukowski, A. Zeilinger, M. A. Home and A. K. Ekert, “'Event-ready-detectors” Bell experiment via entanglement swapping,” Phys. Rev. Lett. 71 (1993) 4287-4290). The center wavelength can be tuned by laser temperature or current (H. Semenenko, P. Sibson, A. Hart, M. G. Thompson, J. G. Rarity and C. Erven, “Chip-based measurement-device-independent quantum key distribution,” Optica 7 (2020) 238). Very tight wavelength control within ˜10 pm is required to maintain high interference visibility as shown in FIG. 10. (The data in this figure are measured for an MDI-QKD system operated in the time-bin/phase shift bases, labelled Z and X, respectively, which are discussed in Section 4.)

FIG. 10 illustrates that, as the wavelength difference between Alice and Bob is varied, the interference fringe visibility due to interference of the photons in the X-basis (entangled between the two different time-bins) decreases (H. Semenenko, P. Sibson, A. Hart, M. G. Thompson, J. G. Rarity and C. Erven, “Chip-based measurement-device-independent quantum key distribution,” Optica 7 (2020) 238). There is no interference between photons in the Z-basis which arrive in separate time-bins. To maintain high interference visibility, the wavelength difference for Alice's and Bob's lasers operating at ˜1550 nm should be <±10 pm.

The overlap of the photon wavefunctions at the BS is determined by the pulse width. A pulse width of 1 ns corresponds to a bandwidth ˜1 GHz. A pulse width of 10 ns corresponds to a bandwidth of ˜100 MHz. The reciprocal pulse width should be about ten times greater than the laser linewidth, so a 10 ns pulse or shorter would work well with DFB lasers. The photons from Alice and Bob then should arrive at Charlie's BS to within about 10% of the pulse width, or within ˜1 ns. TSN is ideally suited for MDI-QKD in this context, because it can open the network channels for Alice and Bob at the appropriate times for their photons to be coincident at Charlie. In other words, a dedicated quantum fiber channel for each edge device to use whenever needed is not required. After the time scheduler selects optical network paths for the photons, then Alice and Bob each send a light pulse to Charlie and send the time at which they sent their pulse to the time scheduler. Charlie measures the photon arrival times and passes those times to the time scheduler. The time scheduler then determines when Alice and Bob must send their QKD photons so that they arrive at Charlie at the same time within about 10% of the pulse width. Of course, this requires clock synchronization between Alice and Bob to within 1 ns or better (H. Semenenko, P. Sibson, A. Hart, M. G. Thompson, J. G. Rarity and C. Erven, “Chip-based measurement-device-independent quantum key distribution,” Optica 7 (2020) 238). We also note that the timing jitter for superconducting nanowire detectors (SNWD) is typically ˜100 ps or less (https://www.thorlabs.com/thorproduct.cfm?partnumber=ULN15PC).

MDI-QKD based on polarization has been successfully implemented using two separate lasers by employing multiple feedback systems (Spec sheet for Quantum Opus superconducting nanowire detectors). The polarization was stabilized through feedback by using a third laser situated at Charlie's setup. The feedback system disabled data collection every 10 s and sent a high intensity pulse for 250 ms to Alice and Bob. They in turn analyzed the light pulses with commercial polarization controllers and used the result to stabilize the polarization state over the fiber channel. In the setup described in this reference, the photon arrival time and laser wavelength are equalized for Alice and Bob by manual adjustment, but in a real-world application there would need to be automated feedback systems to stabilize these parameters as well. The laser wavelength had to be adjusted every 30 minutes to maintain a frequency difference <10 MHz. Photon arrival time was adjusted on a minute basis through a master clock signal from Charlie through a second set of fibers to Alice and Bob. The arrival time difference was kept <30 ps.

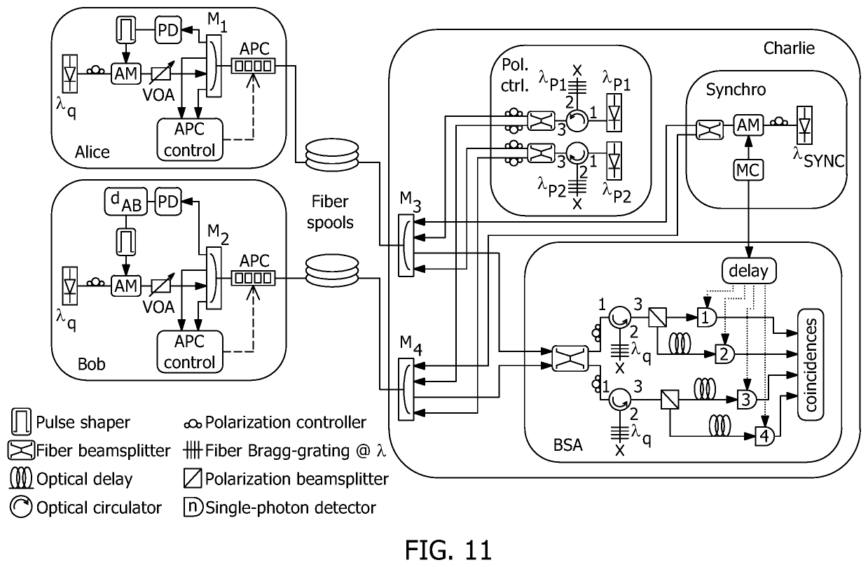

It is important to note that weak coherent lasers are not single photon sources even when the pulse intensity is attenuated by Alice and Bob so that the average number of photons in a pulse is <1 before allowing the pulse to return to Charlie. There is always a certain probability of multiple photons remaining in the pulse. This changes the detection statistics in the anti-diagonal/diagonal (AD) polarization basis (A. Rubenok et al., “Real-world two-photon interference and proof-of-principle quantum key distribution immune to detector attacks,” Phys. Rev. Lett. 111 (2013) 130501), but does not affect the ability of the technique to generate encrypted keys. In another proof-of-principle experiment, shown in FIG. 11, polarization stabilization was carried out with signals from two wavelength-multiplexed lasers on the same fiber sent by Charlie to Alice and Bob, respectively. The polarization analyzers/controllers adjusted the polarization state of these signals to actively cancel effects of fiber birefringence. It should be noted that for chip-level QKD this is far from ideal. The phase variation due to propagation over kilometers of fiber may be difficult or impossible to fully correct on a small photonic integrated chip (PIC). External cavity tunable lasers were also used for both Alice and Bob, another incompatibility with PIC's. These lasers were used to generate 1.5 ns pulses at 1546.12 nm wavelength. A variable optical attenuator reduced the average number of photons per pulse to 0.5 for the signal photons and 0.1 or 0 for the decoy states.

FIG. 11 illustrates an experimental setup. AM: amplitude modulator, PD: photodetector, VOA: variable optical attenuator, SOP: polarization controller to SOP preparation, M: WDM, APC: automatic polarization controller, MC: master clock, d: delay generator.

Prior to beginning key distribution, Charlie calibrated the time interval for sending pulses from Alice and Bob to him. Charlie sent a master clock signal to both Alice and Bob at a different wavelength over the fiber which they in turn used to pulse their lasers. Bob also had an internal timer with which he adjusted the emission time of his pulse so that it arrived at Charlie coincident with Alice's pulse. Furthermore, Charlie's measurements of coincidences had to be properly synchronized (delayed) with respect to Alice's and Bob's photon emission time. Finally, to correct for small wavelength drifts between the two lasers, a separate detector was used to monitor the beat frequency from the interference of a small amount of light split off from each laser. As an alternative to this procedure, it was suggested that a gas cell with an absorption line at the laser wavelength could be used to independently lock the wavelength of each laser. This laser locking technique, however, is not easily incorporated into a PIC.

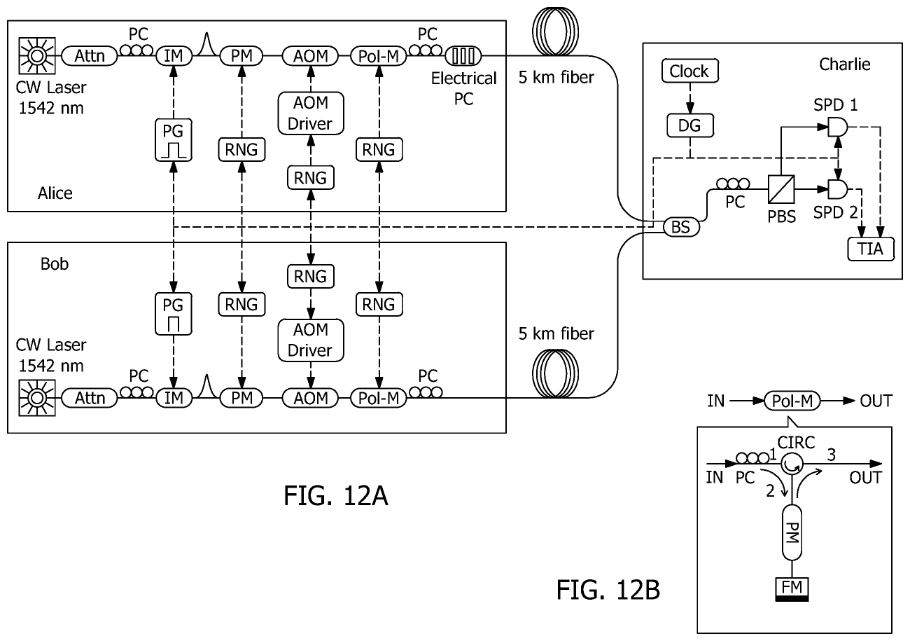

Another demonstration of polarization-encoded MDI-QKD is described in T. Ferreira da Silva, et al., “Proof-of-principle demonstration of measurement-device-independent quantum key distribution using polarization qubits,” Phys. Rev. A 88 (2013) 052303. The design of the apparatus is shown in FIG. 12. In this setup the lasers are both semiconductor lasers that are frequency-locked at 1542.38 nm to an acetylene absorption line with linewidths <50 kHz (Z. Tang, et al., “Experimental demonstration of polarization encoding measurement-device-independent quantum key distribution,” Phys. Rev. Lett. 112 (2014) 190503). The frequency difference is <10 MHz. The pulse width is ˜1 ns, corresponding to a bandwidth of ˜1 GHz. Again, these lasers are not suitable for PICs. The polarization is modulated in the HV and RL bases using the clever design (I. Lucio-Martinez et al., “Proof-of-concept of real-world quantum key distribution with quantum frames,” New J. Phys. 11 (2009) 095001) shown in FIG. 12.

FIG. 12A illustrates an experimental setup of polarization encoding MDI-QKD and FIG. 12B illustrates a schematic of the polarization modulator. Alice and Bob prepare phase randomized weak coherent pulses with attenuators (Attn), intensity modulators (IM) and phase modulators (PM). Decoy states are prepared by acousto-optic modulators (AOM) and key bits are encoded using polarization modulators (Pol-M). Pulses are sent to Charlie for Bell state measurements. A coincidence between two single-photon detectors (SPDs) indicates a successful projection into the |Ψ⁺ [symbol] state. Abbreviations of other components: PC, polarization controller; Electrical PC: electrical polarization controller; PG, electrical pulse generator; RNG, random number generator; DG, delay generator; BS, beam splitter; PBS, polarizing beam splitter; TIA, time interval analyzer. (b) Schematic of the polarization modulator: CIRC, optical circulator; PM, phase modulator; FM, Faraday mirror.

Alice and Bob first use their polarization controllers to align their horizontal polarization axis with Charlie's PBS. Alice also has an electrical polarization controller at her output that is aligned in the horizontal/vertical (HV) polarization basis, so it only affects the right-circular/left-circular (RL) polarizations. Polarization is realigned every hour. The phase modulators, AO modulators and polarization modulators all require randomness obtained from a random number generator. Charlie has an electrical timing delay generator to synchronize the random number generators and the pulse generators. It also is used to ensure that the pulses from Alice and Bob can be independently controlled to 50 ps.

These examples of MDI-QKD illustrate how a few high-speed nodes with more expensive and larger system components can be used to enable QKD communication between many more lower-level nodes that make use of QKD integrated photonic chips without requiring the larger, more expensive components for, or quantum channels between, all edge devices. Such an asymmetric QKD approach has been investigated by several groups (I. Lucio-Martinez et al., “Proof-of-concept of real-world quantum key distribution with quantum frames,” New J. Phys. 11 (2009) 095001; G. Vest, M. Rau, L. Fuchs, G. Corrielli, H. Weier, S. Nauerth, A. Crespi, R. Osellame and H. Weinfurter, “Design and Evaluation of a Handheld Quantum Key Distribution Sender Module,” IEEE J. Sel. Topics Qu. Electron. 21 (2015) 6600607; and M. Ziebell, M. Persechino, N. Harris, C. Galland, D. Marris-Morini, L. Vivien, E. Diamanti and P. Grangier, “Towards On-Chip Continuous-Variable Quantum Key Distribution, European Qu. Electron. Conf. 4 (2015) JSV-4-2).

While MDI-QKD has important advantages with regard to security by removing the detectors from a potential QKD attack, there are still severe disadvantages from the standpoint of implementation on a TSN-based PIC. The primary problem is ensuring that photons from Alice and Bob are identical and that they arrive at the same instant at Charlie's NPBS. However, we can begin to see why TSN might be useful in implementing MDI-QKD from the standpoint of deterministically scheduling the network path over which the two photons travel. The scheduler could be located at Charlie—perhaps as an algorithm running on this node—that not only determines the network path and when to operate any switches along the path, but who also controls the master clock and tells Alice and Bob when to emit their photons. Another advantage of MDI-QKD is that it effectively doubles the distance over which QKD can be achieved.

Multiple QKD protocols may be employed on the same network. Interoperability between different protocols has been discussed in the literature (T. Länger and G. Lenhart, “ETSI standardization initiative ISG-QKD,” New J. Phys. 11 (2009) 055051), but will be challenging to implement. For example, it is possible to convert time-bin/phase encoding into polarization encoding for very fast readout (T. Länger and G. Lenhart, “ETSI standardization initiative ISG-QKD,” New J. Phys. 11 (2009) 055051). The protocol proposed herein is based upon discrete QKD, involving single photons, and a time-bin/phase shift protocol. Continuous-variable QKD (CV-QKD) may enable chip-based solutions for somewhat longer distances between central nodes, but there is still some question about the security of CV-QKD and it will not be discussed further herein. Furthermore, discrete component systems, as opposed to chip-based systems, are more likely to be required for long distance and/or high speed QKD. Standards will be required for interoperability of QKD systems developed by different manufacturers, and these standards will need to be developed for a variety of QKD systems and protocols.

Various components for QKD systems: detectors, light sources, etc. were discussed in detail in the Task 7 report and will not be repeated here.

### A. Bell State Measurements and MDI-QKD

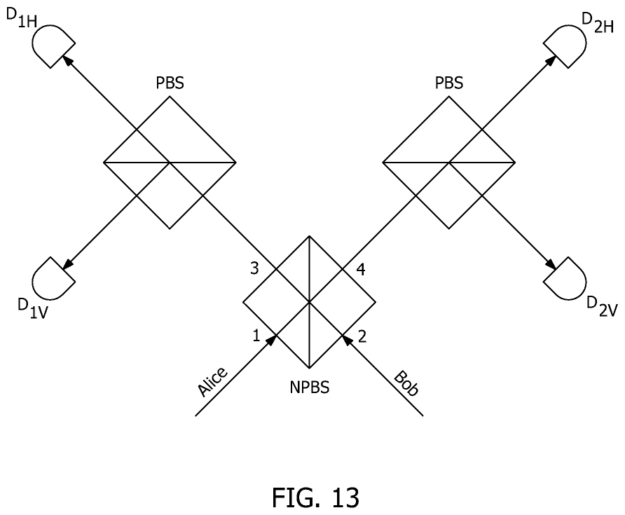

Consider the apparatus shown in FIG. 13 that is typically used for polarization-based Bell state measurements. In this apparatus, two photons are incident upon opposite faces of a 50:50 nonpolarizing beamsplitter (NPBS). Assuming the photons are identical in wavelength and arrive at the same instant in time, they interfere. There are four entangled biphoton Bell states that are represented by the wavefunctions

$${ψ}_{1 , 2} = \frac{1}{\sqrt{2}} ( \vert {H}_{1} , {H}_{2} 〉 \pm \vert {V}_{1} , {V}_{2} 〉 ) = \frac{1}{\sqrt{2}} ( {â}_{1 H}^{†} {â}_{2 H}^{†} \pm {â}_{1 V}^{†} {â}_{2 V}^{†} ) \vert {0}_{1} , {0}_{2} 〉 \qquad ( 1 )$$

$${ψ}_{3 , 4} = \frac{1}{\sqrt{2}} ( \vert {H}_{1} , {V}_{2} 〉 \pm \vert {V}_{1} , {H}_{2} 〉 ) = \frac{1}{\sqrt{2}} ( {â}_{1 H}^{†} {â}_{2 V}^{†} \pm {â}_{1 V}^{†} {â}_{2 H}^{†} ) \vert {0}_{1} , {0}_{2} 〉 \qquad ( 2 )$$

where a^{†} is the photon creation operator and the subscripts denote the incident port, and vertical or horizontal polarization. The wavefunction |0₁, 0₂ [symbol] denotes the vacuum state at the two input ports.

FIG. 13 illustrates a conventional Bell state measurement apparatus.

The transfer relations for the photon creation operators of a photon entering port 1 or 2 and exiting port 3 or 4 of a 50:50 NPBS are (C. Kupchak, et al., “Time-bin to polarization conversion of ultrafast photonic qubits,” Phys. Rev. A 96 (2017) 053812):

$${â}_{1 H}^{†} \to \frac{1}{\sqrt{2}} ( {â}_{3 H}^{†} - \dot{1} {â}_{4 H}^{†} ) \qquad ( 3 )$$

$${â}_{1 V}^{†} \to \frac{1}{\sqrt{2}} ( {â}_{3 V}^{†} - \dot{1} {â}_{4 V}^{†} ) \qquad ( 4 )$$

$${â}_{2 H}^{†} \to \frac{1}{\sqrt{2}} ( {â}_{3 H}^{†} - \dot{1} {â}_{4 H}^{†} ) \qquad ( 5 )$$

$${â}_{2 V}^{†} \to \frac{1}{\sqrt{2}} ( - {â}_{3 V}^{†} + {â}_{4 V}^{†} ) . \qquad ( 6 )$$

Applying these relations to the four Bell states gives

$${ψ}_{1 , 2} = \frac{1}{\sqrt{2}} ( \vert {H}_{1} , {H}_{2} 〉 \pm \vert {V}_{1} , {V}_{2} 〉 ) \to - \frac{i}{2 \sqrt{2}} ( \vert 2 {H}_{3} 〉 + \vert 2 {H}_{4} 〉 \pm \vert 2 {V}_{3} 〉 \pm \vert 2 {V}_{4} 〉 ) \qquad ( 7 )$$

$${ψ}_{3 , 4} = \frac{1}{\sqrt{2}} ( \vert {H}_{1} , {V}_{2} 〉 \pm \vert {V}_{1} , {H}_{2} 〉 ) \to \{ \begin{matrix}- \frac{\dot{1}}{\sqrt{2}} ( \vert {H}_{3} , {V}_{3} 〉 + \vert {H}_{4} , {V}_{4} 〉 ) \\ \frac{1}{\sqrt{2}} ( \vert {H}_{3} , {V}_{4} 〉 + \vert {H}_{4} {V}_{3} 〉 )\end{matrix} \qquad ( 8 )$$

For the first two Bell states, the result in Eq. (7) indicates that both photons arrive at either detectors D_{1H}, D_{1V}, D_{2H}, or D_{2V} but there are never any single photon coincidence counts between different detectors. This is the well-known HOM interference effect (G. Björk and J. Söderholm, “The Dirac-notation in quantum optics,” (2003), available at https://www.kth.se/polopoly_fs/1.263320. 1550156659!/Menu/general/column-content/attachment/Dirac_notation_pm.pdf). This measurement technique cannot distinguish between these two Bell states, which is a well-known principle of linear optics (C. K. Hong, Z. Y. Ou and L. Mandel, “Measurement of subpicosecond time intervals between two photons by interference,” Phys. Rev. Lett. 59 (1987) 2044). On the other hand, the last two Bell states always generate coincidence counts. The Ψ₃ wavefunction will generate a coincidence between detectors on the same output port of the NPBS, while the Ψ₄ wavefunction will generate a coincidence between detectors on opposite output ports of the NPBS.

In the MDI-QKD protocol Alice and Bob randomly and independently select the basis and polarization in which they send out their photons. They typically choose between three bases, the horizontal/vertical polarization basis (HV), the diagonal/antidiagonal polarization basis (AD), or the right and left-circularly polarized basis (RL). If they both happen to choose horizontal polarization in the HV basis, then the input polarization state is

$${ψ}_{in} = \frac{1}{\sqrt{2}} \vert {H}_{1} , {H}_{2} 〉 \qquad ( 9 )$$

which is transformed to the output state

$${ψ}_{out} = \frac{1}{\sqrt{2}} ( \vert {2}_{3 H} 〉 + \vert {2}_{4 H} 〉 ) \qquad ( 10 )$$

There are no coincidence detection events because both photons emerge from the NPBS still horizontally polarized from either port 3 or port 4. Both photons are either detected by D_{1H} or by D_{2H}. The input two photon state has been projected onto either Bell state Ψ₁ or Ψ₂. On the other hand, if Alice chooses horizontal polarization and Bob chooses vertical polarization for their photons then

$${ψ}_{in} = \frac{1}{\sqrt{2}} \vert {H}_{1} , {V}_{2} 〉 \qquad ( 11 )$$

which is transformed to the output state

$${ψ}_{out} = \frac{1}{2} ( - i \vert {1}_{3 H} , {1}_{3 V} 〉 + \vert {1}_{3 H} , {1}_{4 V} 〉 - \vert {1}_{3 V} , {1}_{4 H} 〉 - i \vert {1}_{4 H} , {1}_{4 V} 〉 ) . \qquad ( 12 )$$

Half of the time a coincidence is measured between detectors on the same output side of the NPBS and half of the time a coincidence is measured between detectors on opposite sides of the NPBS. Charlie controls the Bell state measurement apparatus and reports to Alice and Bob the results of all his coincidence measurements: that he measured Bell state 3 (same-side coincidence) or Bell state 4 (opposite-side coincidence). Alice and Bob also separately communicate which basis (HV, AD, or RL) they randomly chose for each photon pulse. All other photon pair detection events are discarded. Thus, the only choices of Alice and Bob that need to be considered are shown in Table 1.

TABLE 1
Probability of coincidence measurement corresponding to Alice′s
and Bob′s input states using NPBS for Bell state measurement

| | | | Opposite | Opposite | |
|---|---|---|---|---|---|
| | | | side | side | |
| | | | coincidences | coincidences | No |
| Alice | | Same side | with opposite | with same | coinci- |
| input | Bob input | coincidences | polarization | polarization | dences |
| H | H | 0 | 0 | 0 | 1 |
| H | V | 0.5 | 0.5 | 0 | 0 |
| V | H | 0.5 | 0.5 | 0 | 0 |
| V | V | 0 | 0 | 0 | 1 |
| D | D | 0.5 | 0 | 0 | 0.5 |
| D | A | 0 | 0.5 | 0 | 0.5 |
| A | D | 0 | 0.5 | 0 | 0.5 |
| A | A | 0.5 | 0 | 0 | 0.5 |
| R | R | 0.5 | 0 | 0 | 0.5 |
| R | L | 0 | 0.5 | 0 | 0.5 |
| L | R | 0 | 0.5 | 0 | 0.5 |
| L | L | 0.5 | 0 | 0 | 0.5 |
| ψ₁ | HH + VV | 0 | 0 | 0 | 1 |
| ψ₂ | HH − VV | 0 | 0 | 0 | 1 |
| ψ₃ | HV + VH | 1 | 0 | 0 | 0 |
| ψ₄ | HV − VH | 0 | 1 | 0 | 0 |

From the table, we see that if Alice and Bob choose the HV basis (Rows 1-4) and Charlie reports a coincidence, then Alice and Bob know that they have sent orthogonally polarized photons. On the other hand, if Alice and Bob have both chosen the AD basis or the RL basis, and Charlie reports a Ψ₃ coincidence, then they know that they have chosen the same polarization, but if Charlie reports a Ψ₄ coincidence, then they know that they have chosen opposite polarizations. Charlie cannot tell which states were initially chosen by Alice and Bob even when he knows that they have chosen the same basis, so Alice and Bob can generate their secure key.

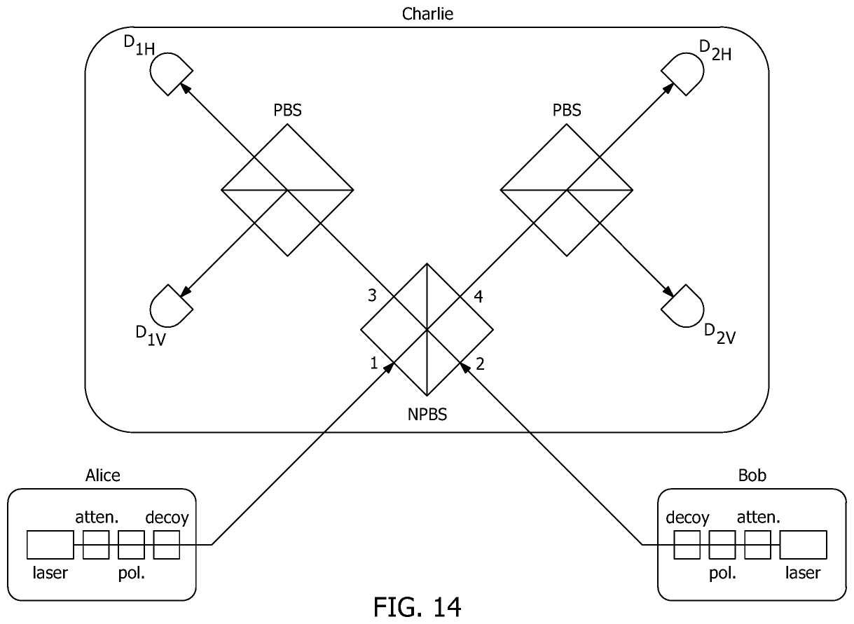

A typical MDI-QKD system design (N. Liitkenhaus, J. Calsamiglia and K.-A. Suominen, “Bell measurements for teleportation,” Phys. Rev. A 59 (1999) 3295-3300) is shown in FIG. 14.

FIG. 14 illustrates a measurement device independent QKD system (MDI-QKD).

Alice and Bob independently generate single photons by attenuating a coherent laser pulse. They modulate the polarization state in 2 or 3 nonorthogonal bases. They insert decoy states and then they send their photon to Charlie who performs a Bell state measurement and announces the result. Of course, for interference to occur, the photons from Alice and Bob must be “identical” in polarization and arrive at Charlie's beamsplitter at the same “instant.”

### B. Modified Bell State Measurement System

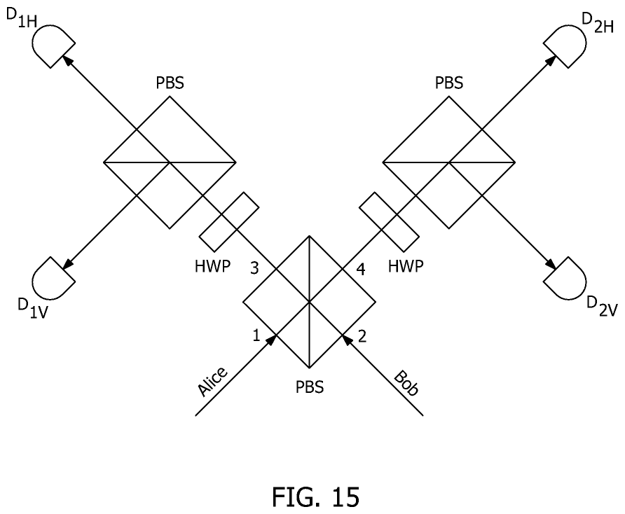

The Bell state measurement system in FIG. 10 makes use of a NPBS to interfere the two incident photons. If this beamsplitter is replaced by a PBS, and the two analyzing PBS's are rotated by 45° as shown in FIG. 15, then we get a modified output state table. In this case, the photon creation state operators are transformed by the PBS as follows.

â_{1H}^{†}→â_{3H}^{†} (3)

â_{1V}^{†}→−i\hat{a}_{4V}^{†} (4)

â_{2H}^{†}→−i\hat{a}_{3H}^{†} (5)

â_{2V}^{†}→â_{4V}^{†} (6)

FIG. 15 illustrates a modified Bell state measurement apparatus. The two half waveplates are oriented at 22.5° so that the transmitted polarization state from the PBS is at 45° to the analyzing PBS's.

Following the same procedure as before, we generate a table that gives the results when Alice and Bob choose the same basis.

TABLE 2
Probability of coincidence measurement corresponding to Alice′s
and Bob′s input states using a PBS for Bell state measurement

| | | | Opposite | Opposite | |
|---|---|---|---|---|---|
| | | | side | side | |
| | | | coincidences | coincidences | No |
| Alice | | Same side | with opposite | with same | coinci- |
| input | Bob input | coincidences | polarization | polarization | dences |
| H | H | 0 | 0.5 | 0.5 | 0 |
| H | V | 0 | 0 | 0 | 1 |
| V | H | 0 | 0 | 0 | 1 |
| V | V | 0 | 0.5 | 0.5 | 0 |
| D | D | 0 | 0 | 0.5 | 0.5 |
| D | A | 0 | 0.5 | 0 | 0.5 |
| A | D | 0 | 0.5 | 0 | 0.5 |
| A | A | 0 | 0 | 0.5 | 0.5 |
| R | R | 0.5 | 0 | 0 | 0.5 |
| R | L | 0 | 0.5 | 0 | 0.5 |
| L | R | 0 | 0.5 | 0 | 0.5 |
| L | L | 0.5 | 0 | 0 | 0.5 |
| ψ₁ | HH + VV | 0 | 0 | 1 | 0 |
| ψ₂ | HH − VV | 0 | 1 | 0 | 0 |
| ψ₃ | HV + VH | 0 | 0 | 0 | 1 |
| ψ₄ | HV − VH | 0 | 0 | 0 | 1 |

When Charlie detects a coincidence event on opposite sides of the first PBS with the same polarization, he has measured the Ψ₁ Bell state. A coincidence on opposite sides of the first PBS with opposite polarizations corresponds to the Ψ₂ Bell state. There are no coincidence events for Ψ₃ or Ψ₄. If Alice and Bob both choose the HV basis, then a coincidence event indicates that they have also chosen the same polarization state. If Alice and Bob choose the DA basis, then a Ψ₁ coincidence event indicates that they have chosen the same polarization while a Ψ₂ coincidence event indicates that they have chosen opposite polarizations.

### 4. Plug-And-Play With Time-Bin And Phase Encoding

Plug-and-play is an interesting QKD approach in which the components required at either Alice or Bob are minimal and relatively inexpensive. In particular, it eliminates the need for detectors and light sources at one end of the channel. An example of a differential phase shift QKD plug-and-play system (C. Zhou et al., “‘Plug and play’ quantum key distribution system with differential phase shift,” Appl. Phys. Lett. 83 (2003) 1692) is shown in FIG. 1 (H-K. Lo, M. Curty and B. Qi, “Measurement-device-independent quantum key distribution,” Phys. Rev. Lett. 108 (2012) 130503).

FIG. 1 illustrates a setup of the “plug and play” differential phase shift quantum key distribution system. LD: laser diode. C1-C4: 50%:50% fiber couplers; u: variable phase controller; A: attenuator. PM: integrated phase modulator; and FM: Faraday mirror. Monitor: phase drift control circuit.

In this design, Bob generates light pulses and sends them through two identical Mach-Zehnder interferometers. As a result, there are three output pulses. One pulse propagates through both short arms of the interferometer, one pulse through both long arms, and a third pulse which propagates through either of the two short-long arm paths. A phase of shift of 2π/3 in the long arm of one interferometer ensures that when these two photon paths recombine and interfere, the resulting photon amplitude is equal to that of the other two pulses. It should be noted that though we are discussing this in terms of light “pulses,” each photon in the pulse is itself entangled into a superposition of the three optical paths by this double interferometer design. Alice attenuates the pulses to a single (entangled) photon level and applies a random phase shift of π/3 or 490 /3 to the first pulse, and 0 or π to the third pulse. No phase shift is applied to the second pulse.

On the return path at Bob, the arm lengths of MZ₂ are chosen so that the second pulse traveling through the short arm of the interferometer interferes with the first pulse traveling through the long arm. Similarly, the third pulse traveling through the short arm interferes with the second pulse traveling through the long arm. As a result, only four pulses emerge on the return path from MZ₂. The pulses are then shunted into two detectors before reaching MZ₁. Due to the phase shifts applied to the pulses, the two center pulses will split between detectors 1 and 2 at Bob. Bob knows which detector has measured a photon, while Alice knows which random phase shifts that she has applied and so she can predict which of Bob's detectors will respond for each pulse. In this way, a random key can be exchanged between Alice and Bob without Alice needing detectors or light sources.

Although it should be possible to integrate this design into a chip for Alice, the system design at Bob's end is complex. Bob's Mach-Zehnder interferometers (MZIs) require lengths of fiber in their short and long arms. The two interferometers must be tightly matched, which means extremely good temperature control of the fiber arms as well as feedback systems to constantly maintain the interferometer arm lengths. If the MZI's can be replaced with free space Michelson interferometers, this stringent temperature control requirement may be somewhat relaxed. Alice has a Faraday rotator to eliminate effects of birefringence in the fiber channel, and, as we will show, this function can be accomplished on-chip. Although the photons make a round trip between Alice and Bob, the distance advantage of MDI-QKD is not lost because the photon beam emitted from Bob is a bright, many photon beam. It is only on the return trip that Alice has attenuated the beam to less than one photon on average per pulse that restricts the channel distance. Bob can be located at a central hub of a star network as in FIG. 9, but the hub must be a trusted node.

It should be noted that the QKD technique illustrated in FIG. 13 does not rely on polarization encoding, but rather on time-bin/phase shift encoding. The two unbalanced MZIs in Bob's system are connected in series and must be controlled to have exactly the same lengths for their short and long arms. A single light pulse from the laser is split into two pulses by the MZI's. Because of the equal arm lengths, the total time for a light pulse to propagate through the short arm of the first MZI and long arm of the second MZI is equal to the time for a pulse to propagate through the opposite arms of the MZI's, so these two pulses overlap in time, and only three separate pulses emerge from the cascaded MZIs. There is a variable phase shifter in the long arm of the first MZI which applies a fixed θ=2π/3 phase shift to the light pulse. The wavefunction for each of the three “single photon” pulses can be written

$$\vert {ψ}_{ss} 〉 = \frac{1}{2} {e}^{- i {φ}_{0}} \vert {t}_{1} 〉 \qquad ( 7 )$$

$$( 8 )$$

$$\vert {ψ}_{s 1 + 1 s} 〉 = \frac{1}{2} {e}^{- i {φ}_{0}} \vert {t}_{2} 〉 + \frac{1}{2} {e}^{- i ( {φ}_{0} + θ )} \vert {t}_{2} 〉 = cos ( \frac{θ}{2} ) {e}^{- i ( {φ}_{0} + \frac{θ}{2} )} \vert {t}_{2} 〉 = \frac{1}{2} {e}^{- i ( {φ}_{0} + \frac{π}{3} )} \vert {t}_{2} 〉$$

$$\vert {ψ}_{11} 〉 = \frac{1}{2} {e}^{- i ( {φ}_{0} + θ )} \vert {t}_{3} 〉 = \frac{1}{2} {e}^{- i ( {φ}_{0} + \frac{2 π}{3} )} \vert {t}_{3} 〉 . \qquad ( 9 )$$

By choosing this value for the phase shift θ, the interference between the two pulses at the middle time frame causes the amplitude of all three pulses to be equal. A light intensity feedback system was used to continually adjust the phase shift at Bob's system to ensure pulse amplitude equality.

Alice attenuates the reflected pulses to the single photon level and she applies a random phase shift of π/3 or 4π/3 to the first pulse, leaves the second pulse unchanged, and applies a random phase shift of π/3 or 4π/3 to the third pulse (C. Zhou et al., “‘Plug and play’ quantum key distribution system with differential phase shift,” Appl. Phys. Lett. 83 (2003) 1692). When the returning photon reaches Bob, it passes through only the first MZI and the two outputs of the MZI are then directed to two detectors. The MZI has the effect of converting the three different pulse times into four time bins. It is the center two time bins that involve interference with Alice's applied phase shift. The results for these two time bins are shown in Table 3.

Bob reports to Alice (even on an unsecure channel) in which time bin he recorded a detection event. Bob does not report which detector measured the event, but Alice knows which phase shift she applied, and Bob knows which detector clicked, so they each can then proceed to generate the secret key.

TABLE 3
Probability of detection event at Bob′s detectors 1 and 2 due to
Alice′s time shift

| | Alice′s phase | Relative phase shift between | | |
|---|---|---|---|---|
| Time slot | shifts | pulses at output of Bob′s MZI | DET 1 | DET 2 |
| 2 | π/3 to \|t₁ [symbol] | 0 | ✓ | x |
| 2 | 4π/3 to \|t₁ [symbol] | π | x | ✓ |
| 3 | π/3 to \|t₃ [symbol] | 0 | ✓ | x |
| 3 | 4π/3 to \|t₃ [symbol] | π | x | ✓ |

### 5. Plug-and-Play With MDI-QKD and Time-Bin/Phase Encoding

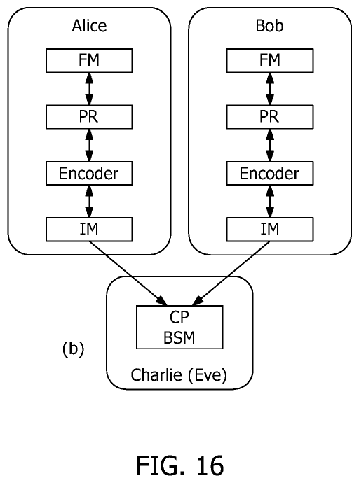

A more interesting QKD technique combines both measurement device independence and plug-and-play (Note: the original paper claims that Alice should apply a phase shift of 0 or π to the third pulse, not π/3 or 4π/3. However, this phase shift does not seem to provide the desired 0 or π relative phase shift to the second pulse; F. Xu, “Measurement-device-independent quantum communication with an untrusted source,” Phys. Rev. A 92 (2015) 012333). As previously noted, for MDI-QKD to work, the photons prepared by Alice and Bob must be identical in time, wavelength, and polarization when they reach Charlie's NPBS. In practice this is challenging and is not easily implemented within a PIC. Sometimes lasers are frequency-locked using gas cells. Other times, DFB lasers are continuously adjusted with temperature controllers. Drifts in photon polarization and arrival times must also be continuously monitored and actively controlled with instruments that are usually large and expensive. Over 20 km of fiber, the travel time of an optical pulse can drift by up to 30 ns (Y. Choi et al., “Plug-and-play measurement-device-independent quantum key distribution,” Phys. Rev. A 93 (2016) 032319). An obvious solution to the problem of wavelength control is for a single light source to be located at Charlie's node so that the same source generates the photons for both Alice and Bob. A block diagram of this system is shown in FIG. 16. In this technique Charlie sends strong coherent pulses through a 50:50 beamsplitter to Alice and Bob. Alice and Bob both use Faraday mirrors to rotate the incident polarization state by 90° when reflecting photons back to Charlie. The phase shift between horizontal and vertical polarizations that accrues from traveling through the fiber channel from Charlie to Bob or Alice is then “undone” in the reflected pulse with rotated polarization so that when the pulse reaches Charlie it is again linearly polarized, though the polarization is rotated by 90°. This effectively eliminates polarization errors due to birefringence in the fiber cable. The encoder and intensity modulator at Alice and Bob adjust the signal and decoy pulse amplitudes and phases randomly and appropriately to ensure that photon number splitting attacks can be detected. Charlie makes a Bell state measurement on the photons reflected from Alice and Bob to determine their entanglement state. He announces the results of his measurement on a public channel to Alice and Bob after which they can generate their secret key, knowing the random phase shifts they each used to encode their reflected photons. Because polarization drift is eliminated through the Faraday mirror, and the wavelength of both photons is automatically identical, the only remaining issue to ensure indistinguishability and entanglement of the returning photons from Alice and Bob is that they arrive at the same instant at Charlie's NPBS.

FIG. 16 illustrates a plug-and-play MDI-QKD protocol. CP, coherent (outgoing) pulse; encoder, the device that encodes bit information; IM, intensity modulator; FM, Faraday mirror; PR, phase randomizer; BSM, Bell state measurement. In a conventional MDI-QKD protocol, Alice and Bob prepare pulses independently, and send them to Charlie for Bell state measurement. In plug-and-play MDI-QKD, Charlie initially launches pulses to Alice and Bob, and then Alice and Bob reflect back the pulses to Charlie.

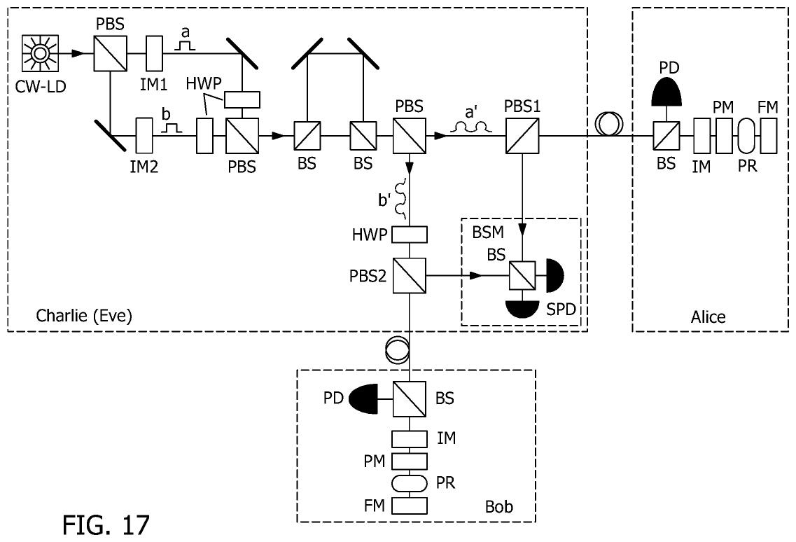

A specific implementation of P&P MDI_QKD discussed in C. Zhou et al., “‘Plug and play’ quantum key distribution system with differential phase shift,” Appl. Phys. Lett. 83 (2003) 1692 is shown in FIG. 17 and is based upon phase shift interferometry with time-binning.

FIG. 17 illustrates a proposed setup for P&P MDI-QKD using time-bin/phase encoding. The synchronization for different distances between Charlie to Alice and Charlie to Bob is actively controlled with IM1 and IM2. CW-LD, continuous-wave laser diode; IM, intensity modulator; HWP, half wave plate; PBS, polarizing beam splitter; BS, beamsplitter; PD, photodiode; PM, phase modulator; SPD, single-photon detector.

There are some important features of this design. The light source is a continuous (CW) laser. Typically, this may be a diode laser as shown here because these are low cost and can operate in the telecom band, but it could be any other type of CW laser source including gas lasers, solid-state lasers, frequency-doubled lasers, etc. A PBS splits the output to provide an “a” pulse for Alice and a “b” pulse for Bob. Separate intensity modulators are used, one to generate pulses for Alice and one for Bob, to achieve perfect timing between the pulses so that they coincide upon return to Charlie's detectors. The emission times of the pulses are controlled by Charlie who has previously determined the round-trip travel times of light pulses to Alice and Bob. In general, IM1 and IM2 will emit pulses at very different times depending on the total fiber path length between Charlie and Alice or Bob. A single laser is used to send one pulse to Alice and one to Bob at two separate times to ensure that the emitted photons have the same wavelength. Half waveplates (HWP) are used to recombine the two pulses at another PBS. Two NPBS's are used to create an unbalanced MZI for the time-shift encoding, thereby splitting each pulse into two pulses (or more accurately, each photon in the pulse becomes entangled in two separate time-bins) and finally another PBS again splits the “a” and “b” pulses for Alice and Bob, respectively. Alice and Bob receive the relatively high-power pulses from Charlie and immediately split off a portion of each pulse to generate timing information and protect against bright light attacks from Eve. They each then use an intensity modulator to reduce the photon number in the return pulse to <1, a phase modulator that randomly time-shifts the phase between the pulse pair by 0 or π, and a Faraday rotator to return the photon in the orthogonal polarization. A photon entangled between the two time-bins in the phase shift basis can be represented as

$$\vert {ψ}_{x} 〉 = \frac{1}{\sqrt{2}} ( \vert {t}_{1} 〉 + {e}^{i ϕ} \vert {t}_{2} 〉 )$$

where ϕ is the relative phase shift between the pulses in bin 1 and bin 2. For the two phase shift states {0,π}, this corresponds to replacing the e^{iϕ} factor by ±1.

The return photons are split off by PBS's and interfered by Charlie in a Bell state measurement. It should be noted that there is also a phase randomizer at both Alice and Bob to ensure that there is no remaining coherence from Charlie's laser between Alice's and Bob's photon, which can in principle make the channel susceptible to an “unambiguous state discrimination” eavesdropping attack (D. Stucki et al., “Long-term performance of the SwissQuantum quantum key distribution network in a field environment,” New J. Phys. 13 (2011) 123001; C. H. Park et al., “Practical plug-and-play measurement-device-independent quantum key distribution with polarization division multiplexing,” IEEE Access 6 (2018) 58587).

Although this technique successfully combines both plug and play with MDI-QKD, which simplifies the device structure for both Alice and Bob, it still requires the unbalanced interferometer at Charlie which requires a fiber loop and some degree of temperature control.

Another MDI-QKD system design that is also “plug-and-play” has been described in D. Stucki et al., “Long-term performance of the SwissQuantum quantum key distribution network in a field environment,” New J. Phys. 13 (2011) 123001 and the system block diagram is shown in FIG. 1A4. This system design is similar to, but an improvement upon, the design in Ref [Error! Bookmark not defined.].

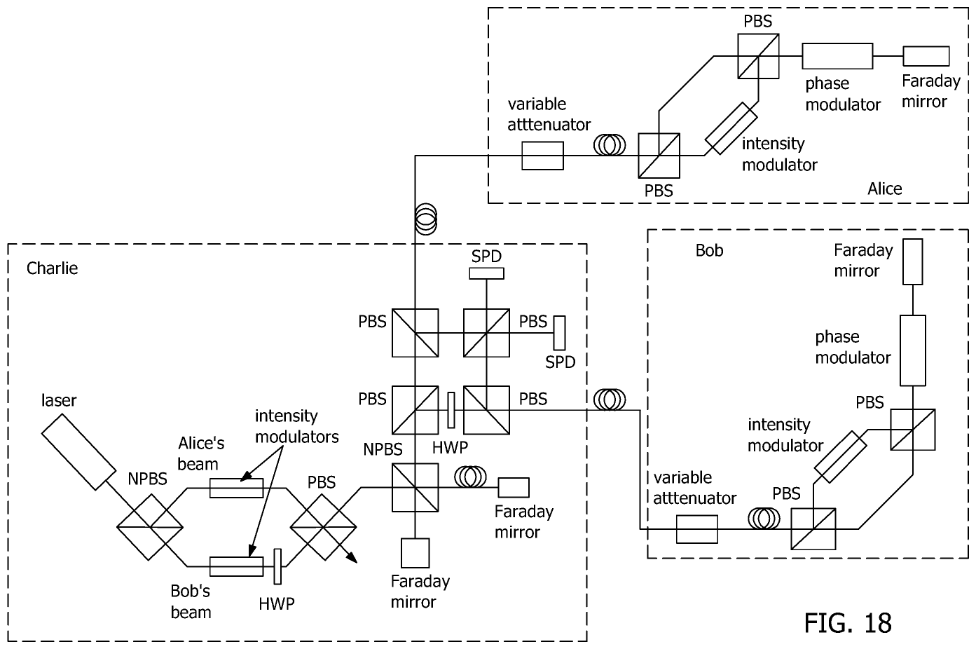

FIG. 18 illustrates a P&P MDI-QKD system design using time-bin phase encoding. Not shown is a 2×n optical switch at Charlie that connects the two inputs/outputs from Charlie to the appropriate edge devices if there are multiple edge devices. Alice and Bob use their respective intensity modulator and phase modulator to randomly encode the time-bin or phase shift states into the photon(s) returned to Charlie.

This system again relies on an attenuated laser with decoy states and a Bell state measurement. In this case, however, the light source is located with the detectors at Charlie's node. This is a significant improvement for chip-based QKD. Now the PICs at Alice's and Bob's nodes do not need to include any of the expensive components that are also very difficult to integrate into a chip.

A significant difference with this system is that it makes use of time-bin/phase encoding rather than polarization state encoding. This makes the entire network system relatively immune from the birefringence effects of optical fiber, another significant advantage. This system operates in the following manner. Charlie generates a vertically-polarized coherent CW beam from a laser diode that is evenly split by a NPBS. One half of the beam is for Alice and other for Bob. Intensity modulators turn these beams into pulses. Not shown in the diagram is a means for ensuring randomness in the phases of each pulse for Alice and Bob. This is important for guarding against the unambiguous state discrimination attack (C. H. Park et al., “Practical plug-and-play measurement-device-independent quantum key distribution with polarization division multiplexing,” IEEE Access 6 (2018) 58587; H-K. Lo and J. Preskill, “Security of quantum key distribution using weak coherent states with nonrandom phases,” Qu. Infor. Comp. 7 (2007) 431-458). Each pulse for Alice is paired with a pulse for Bob with a fixed relative time shift between them so that when the paired photons from Alice and Bob eventually return to Charlie, they arrive at his PBS at the same time. A half waveplate (HWP) rotates the polarization state of Bob's beam by 90° to horizontal. The two beams are then recombined by a PBS. Alice's beam is now reflected by the PBS and remains vertically polarized. Bob's beam is transmitted by the PBS and remains horizontally polarized.

Both beams are split evenly by a NPBS and sent to unbalanced arms of a Michelson interferometer. The beams are reflected by Faraday mirrors so that their polarization is rotated by 90°. When they reenter the PBS, they are sent to the opposite port. Alice's beam, which was vertically polarized, is now horizontally polarized. Bob's beam has also been rotated in polarization. In addition, both Alice's and Bob's pulses have been split into two pulses of equal intensity by the unbalanced interferometer.

The next PBS then transmits Alice's pulses to the fiber that carries the pulses to her node. Bob's pulses get reflected by the PBS and sent towards his node. A HWP ensures that Bob's pulses are rotated back to horizontal polarization and transmitted by the next PBS into the fiber, while Alice's pulses are already properly horizontally polarized to be transmitted through the PBS and coupled into the fiber. When both sets of pulses leave Charlie's node, they are both horizontally polarized.

Alice's and Bob's devices are identical. The incident beam, which still consists of a large number of photons, is first attenuated and then split by a PBS. It should be noted that after transmission through the birefringent fiber, the polarization state of the light entering the PBS in Alice's or Bob's setups will generally be in some arbitrary polarization state. It will not in general be split evenly by the PBS, but different amplitudes of light will be split into the two optical paths. One path includes an intensity modulator that is designed to block one of the two pulses, randomly. By splitting the light with the PBS, it only passes one-way through the intensity modulator which may make the intensity control more precise, though in a related paper the two PBS's were not employed and the light just made a double-pass through the intensity modulator (H. Ko, B-S. Choi, J-S. Choe and C. J. Youn, “Advanced unambiguous state discrimination attack and countermeasure strategy in a practical B92 QKD system,” Qu. Infor. Proc. 17 (2018) 17). The light also passes through a phase modulator that adds an extra it-phase shift at random to the pulses. These are the two orthogonal bases for this system. The light is reflected by another Faraday mirror, thereby rotating its polarization by 90°. The part of the pulse that passed through the intensity modulator on the way in, now bypasses it on the way out, and vice-versa. A variable attenuator ensures that only a fraction of a photon in each pulse is passed back to Charlie. Because of the Faraday rotator, when the photons return to Charlie, their polarization is again linear and rotated by 90° to vertical in spite of any birefringence in the fiber thanks to the effect of the Faraday rotators. Therefore, the photons returning to Charlie from Alice and Bob are reflected by the first PBS they encounter and then arrive at a second BS simultaneously in the same polarization state for a Bell state measurement as described in the previous section.

A valid BSM occurs when Charlie measures a photon on opposite detectors in different time bins. If Alice and Bob select the time-bin basis, so that their photons arrive at Charlie's BS in either the first time-bin or the second, then when they choose opposite time-bins, there is a 50% chance that a photon from Alice or Bob will strike either detector—they are random and uncorrelated. If Alice and Bob, however, select the same time-bin, then two identical photons arrive at the NPBS at the same time. This is analogous to the HOM interferometer (Y. Choi, O. Kwon, M. Woo, K. Oh, S-W. Han, Y-S. Kim and S. Moon, “Plug-and-play measurement-device-independent quantum key distribution,” Phys. Rev. A 93 (2016) 032319) and both photons strike one or the other detector—there is no coincidence.

If Alice and Bob both choose the phase shift basis, then a coincidence on opposite detectors will occur when one of them has added a relative phase shift of π between the two time-bins of their entangled photon and the other has chosen no relative phase shift. (Alice and Bob could also include a ±π/2 basis. (C. K. Hong, Z. Y. Ou and L. Mandel, “Measurement of subpicosecond time intervals between two photons by interference,” Phys. Rev. Lett. 59 (1987) 2044) A table illustrating the detection criteria for the different bases is shown below.

TABLE 4
Probability of detection event at Charlie′s detectors in time-
bin/phase shift technique

| Relative | Coincidence | Two sequential | Two photons |
|---|---|---|---|
| phase/time- | on opposite | pulses on same | simultaneously on |
| bins | detectors | detector | same detector |
| Δϕ: 0 | 0 | 0.5 | 0.5 |
| Δϕ: π | 0.5 | 0 | 0.5 |
| Same time- | 0 | 0 | 1 |
| bin | | | |
| Opposite | 0.5 | 0.5 | 0 |
| time-bins | | | |

When Charlie announces all the coincidences on opposite detectors that he measured, and Alice and Bob sift that list to determine which coincidences occurred when they both chose the same basis, then Alice and Bob, knowing the time-bin or phase shift that they themselves selected, will immediately know the state that the other selected as well and they can generate their secret key. When multiple photons arrive from either Alice or Bob in the phase shift basis, there can be accidental coincidences and a 50% error rate (Z. Tang, Z. Liao, F. Xu, B. Qi, L. Qian and H-K. Lo, “Experimental demonstration of polarization encoding measurement-device-independent quantum key distribution,” Phys. Rev. Lett. 112 (2014) 190503.)

In order for interference to take place, it is critical that the photons be indistinguishable in wavelength, polarization, and timing. The wavelength criterion is automatically fulfilled by using the same laser for photon generation for Alice and Bob. Polarization is also automatically fulfilled by the optics including the Faraday mirrors that correct for fiber birefringence. Therefore, the challenge in this QKD system is ensuring that the photons from Alice and Bob arrive at the same time at Charlie's NPBS. However, the timing error just needs to be small compared to the pulse length. In particular, the length of the pulses emitted by Charlie to Alice and Bob should be at least ten times longer than the inverse frequency linewidth of the laser and the electronic timing jitter in the pulse emission (Z. Tang, Z. Liao, F. Xu, B. Qi, L. Qian and H-K. Lo, “Experimental demonstration of polarization encoding measurement-device-independent quantum key distribution,” Phys. Rev. Lett. 112 (2014) 190503). Using longer pulses than this simply reduces the key rate. A typical pulse length is ˜2 ns. The wavefunction for a single photon defines the uncertainty in the photon wavelength. A photon wavefunction that is longer in time can have a much lower uncertainty in its frequency and vice versa. By making the pulse width ten times longer than the inverse laser linewidth, the actual linewidth of the emitted photon is then determined by the laser rather than by the pulse shaper. A longer the pulse provides a narrower the band of frequencies, but never smaller than the inherent linewidth of the laser.

It should also be pointed out that because two detectors are used, the efficiency of detecting both photons is proportional to the square of the single photon detector efficiency. Therefore, there is a premium on high efficiency SPD's. (Note that efficiency is the probability that a photon which strikes the detector generates a pulse. Probability of detection, on the other hand, includes the effects of all the intervening optics.)

### 6. Star Network Connections

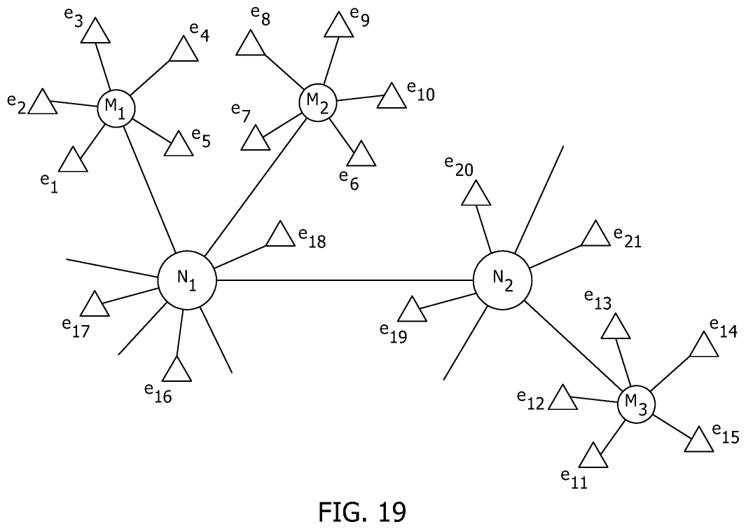

The Charlie nodes contain the light source and detectors and may be located at either first nodes or second nodes in the network diagram in FIG. 6. Because the Charlie nodes are expensive in terms of equipment, electrical power, fiber switching capability, timing ability, maintenance, etc., it is desirable to have as few of these nodes as possible. In FIG. 19, the end/edge devices are triangles, the substations are smaller circles, and the central stations, perhaps one per metropolitan area, are the larger circles. The end devices may be sensors or controls and they connect to and communicate with the network through an edge device. The end device may also be a laptop with which a technician is connecting to the network to monitor other local end devices. It is possible that one edge device (a sensor) would need to communicate directly and immediately with another edge device (a control) without any delays from sending the message through a power grid substation, so there are potentially classical channels between edge devices which could be WiFi, for instance. If so, the two edge devices can initially generate a QKD key via a quantum channel to a Charlie node at a circle substation and then communicate through a separate available classical channel.

FIG. 19 illustrates a star network design used to illustrate locations for Charlie nodes.

It is also possible that a technician connected to the network at one edge node may need to communicate securely with a sensor or control at a different edge node. If the Charlie nodes are located at the smaller circles, then any two edge devices may be used to generate secure QKD keys. For example, if e₂ needs to communicate with e₁₁, the TSN scheduler sets up a fiber channel that connects either the M₁ or M₃ Charlie node to both edge nodes. In either case, the N₁ and N₂ nodes would simply be optical routers for the quantum channel (Z. Tang, Z. Liao, F. Xu, B. Qi, L. Qian and H-K. Lo, “Experimental demonstration of polarization encoding measurement-device-independent quantum key distribution,” Phys. Rev. Lett. 112 (2014) 190503; J. Li and C. Yang, “The design of a quantum Benes switch,” 2007 IEEE Conf. Electr. Dev. Sol.-State Circuits, Tainan, (2007) 539-544, doi: 10.1109/EDSSC.2007.4450181. They would not be involved in any QKD measurements directly.

Is it possible to locate the Charlie nodes only at the many fewer larger circle N nodes instead of the smaller M nodes in order to save the expense of light sources and single photon detectors as well as the amount of periodic maintenance costs? In other words, is it possible to make the M nodes just simple routers that connect desired edge devices to the N nodes? With only a single quantum fiber channel between the samller M nodes and the larger N Charlie nodes, there could be problems generating secure keys between some nodes. For example, if edge node e₂ needs to communicate securely with edge node e₄ that is connected to the same smaller node M₁, and Charlie is located at the larger N₁ node, then the N₁ node needs to send photon pulses through a single quantum fiber channel between N₁ and M₁ to both edge nodes. We could send two separate pulse streams for Alice and Bob between the N node, Charlie, and the M node, Douglas, by ensuring that the pulse streams are orthogonally polarized, but after traveling through fiber between N₁ and M₁ the photons are in an undetermined, generally elliptical, polarization state due to the fiber birefringence. There is no simple way using a PBS, for example, to then separate the pulse streams for Alice and Bob. Wavelength division multiplexing (WDM) is also often used to send information to multiple end points over a single fiber channel. In this case, however, the photons sent to Alice and Bob must have the same wavelength in order to interfere at Charlie, so WDM is not an option. However, there are several potential solutions to this problem.

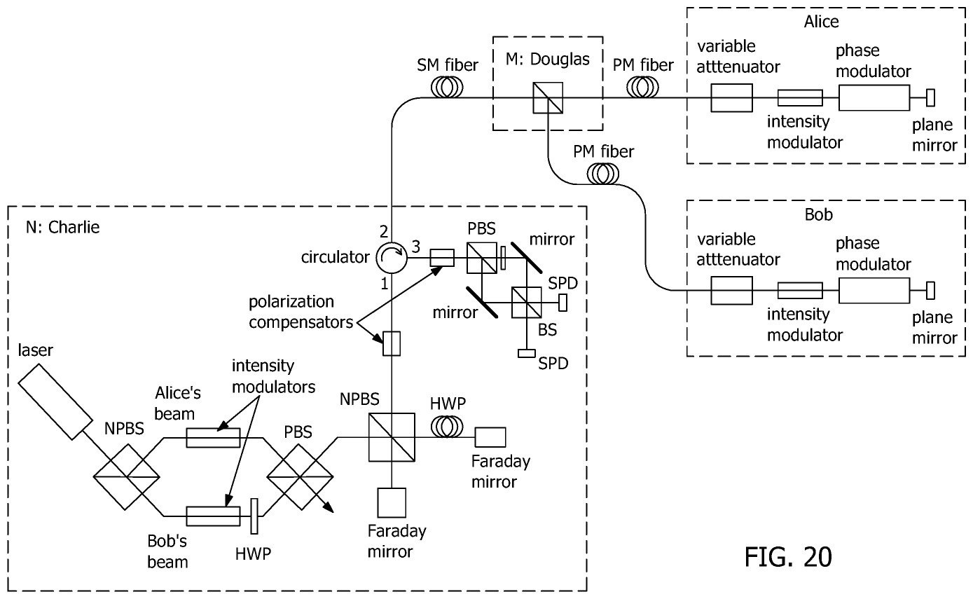

1) The fiber birefringence between the N node and the M node can be constantly measured, for example, by measuring the birefringence at two neighboring wavelengths on either side of the QKD channel and interpolating. As shown in FIG. 20, polarization correction can then be applied at the N node using a polarization controller to precompensate for the fiber birefringence so that the light arrives at the M node in its original polarization basis, i.e., either vertically or horizontally polarized. In this case, the M node then consists solely of a PBS to split the pulse trains to Alice and Bob. The Faraday mirrors at Alice and Bob in FIG. 18 must now be replaced by plane mirrors. If the Faraday mirrors were kept at Alice and Bob, the reflected beams from Alice and Bob would be orthogonally polarized at Douglas, such that reflected beams would exit the wrong port of the PBS at Douglas. However, a plane mirror does not automatically compensate for the round-trip fiber birefringence. Therefore, PM fiber is now required between the Douglas and Alice and Bob to maintain the horizontal or vertical polarization state of the two beams. An advantage of this approach is that existing single mode (SM) fiber can be used between the N and M nodes which usually are separated by a long distance and have fiber cables already installed. Furthermore, Douglas' setup becomes a very simple polarizing beamsplitter, and the components for Alice and Bob are much simpler and easier to integrate into a PIC. A disadvantage is that PM fiber must be used between Douglas and Alice and Bob, but if Douglas, Alice and Bob are all in close proximity, this may not be a big disadvantage. The primary disadvantage is that Charlie's setup now becomes much more complex. He must measure the birefringence in the fiber between himself and Douglas and then continually adjust for it at two different positions in the optical path, including a circulator for proper routing of the reflected beam as well.

FIG. 20 illustrates a modified plug-and-play MDI-QKD arrangement that enables a separate router node, M₁, between Charlie and Alice and Bob by using polarization controllers to adjust for fiber birefringence between Charlie and Douglas. Not shown is the 2×n optical switch at Douglas' node that ensures the two inputs/outputs from Douglas' PBS are connected to the proper edge devices.

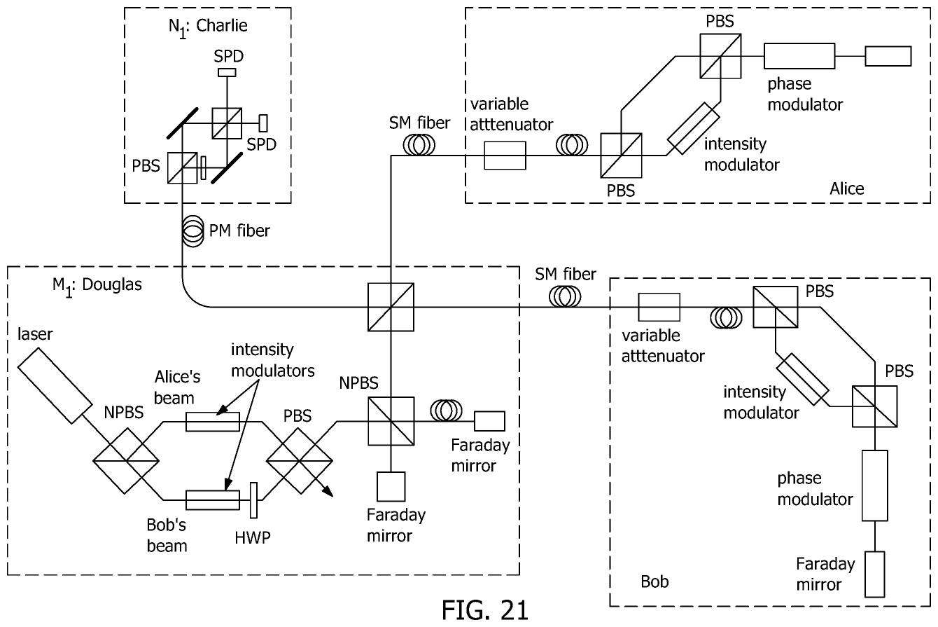

2) A straightforward approach for placing all detectors at Charlie's N node is to use polarization maintaining fiber between all M and N nodes for the quantum channel as shown in FIG. 21. In this case, however, Charlie's node does not contain the light source, which is now located at Douglas' node. Alice and Bob remain the same as in FIG. 18 with Faraday mirrors that automatically compensate for birefringence in the SM fiber between Douglas and Alice and Bob. This approach has several disadvantages. PM fiber is more expensive than SM fiber so one would prefer not to use it over the long distances that might be between Charlie and Douglas. Furthermore, SM fiber may already be installed and available on the network rather than the more expensive PM fiber. Having to include a laser light source and associated optics at Douglas' node increases the cost and routine maintenance of the system. However, the most expensive components, the single photon detectors, are now located at the few Charlie nodes.

Most of the components for the M nodes could in principle be integrated onto a PIC chip, though it would be much easier with current technology to build the M nodes from discrete components. The most difficult components to integrate into the M nodes are the laser diode and the optical delay line. However, these components have been successfully integrated (L. Lu, S. Zhao, L. Zhou, D. Li, Z. Li, M. Wang, X. Li and J. Chen, “16×16 non-blocking silicon optical switch based on electro-optic Mach-Zehnder interferometers,” Opt. Exp. 24 (2016) 9295-9307). A delay line of 7 m (35 ns) was demonstrated in an integrated chip with a total loss of 0.56 dB and potential for loss reduction down to 0.01 dB/m (P. Sibson, et al., “Chip-based quantum key distribution,” Nat. Commun. 8 (2017) 13984). Another issue in fabricating the M node into a PIC may be the optical losses occurring at the light couplers for getting light off and on the chip. Although PM fiber is required between N and M nodes in this case, the most expensive components, the single photon detectors, are located now at the highest level of the network with the fewest nodes.

FIG. 21 illustrates a modified plug-and-play MDI-QKD arrangement that enables a separate router node, M₁, between Charlie and Alice and Bob by making use of polarization orthogonality and PM fiber. Not shown is the 2×n optical switch that ensures the two outputs from Douglas are connected to the proper edge devices.

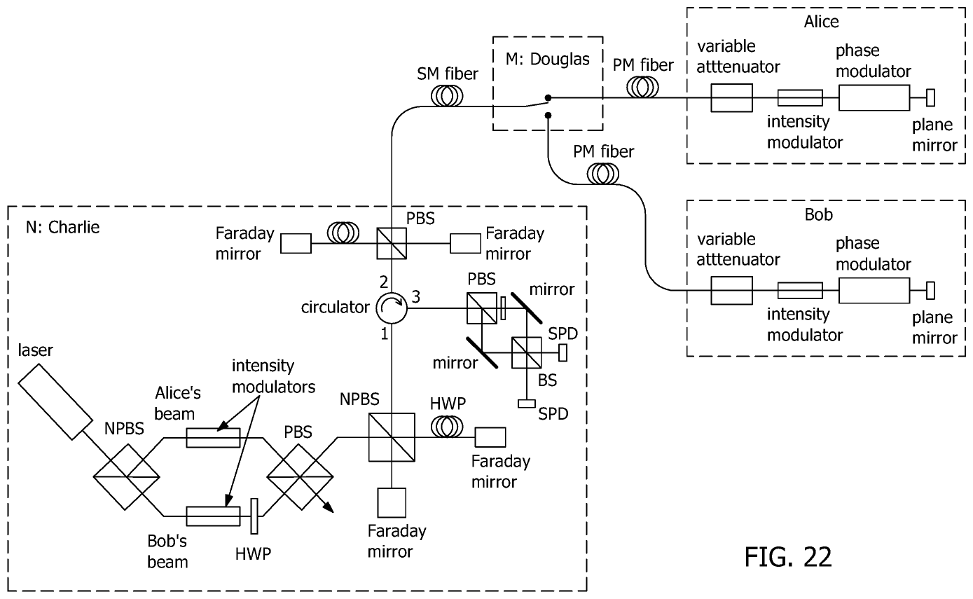

3) Another way to multiplex the light pulses to Alice and Bob over a single fiber between Charlie and Douglas is through timing as shown in FIG. 22. Suppose the round-trip time for a light pulse to travel between Charlie and Alice is τ₁ and between Charlie and Bob is τ₂. If the difference in time is sufficiently great, then Charlie might be able to send all pulses to Bob followed by all pulses to Alice so that they return to Charlie at the same time. Assume that photon pulses can be sent at a GHz rate and that 10,000 pulses are required per key. Then one pulse string requires 10 microseconds. At 5 ns/m delay in optical fiber for the speed of light, this time corresponds to a propagation distance of 2 km, or a round-trip distance of 1 km. If the distance between Charlie and Bob is 1 km greater or smaller than that between Charlie and Alice, then indeed the two pulse streams will not overlap on their way out to Alice and Bob. Douglas must use a fast optical switch to first send one stream to Bob and the other stream to Alice. However, after returning from Bob and Alice, the two pulse streams now coincide, so Douglas' switch will not be able to send both streams back to Charlie.

This problem can be overcome by generating the time delay between the two pulse streams at Charlie's node. Because the physical distance between Douglas and either Alice or Bob is most likely very similar according to the star network design, this approach may make more sense anyway. As shown in FIG. 22, after generating the dual pulse stream for Alice and Bob, Charlie specifically adds a relative time delay between the two pulse streams, again using an unbalanced Michelson with an extra length of fiber in one arm that is ˜1 km or more. This unbalanced interferometer uses a PBS rather than a NPBS so that it creates a relative time delay between the pulse streams for Alice and Bob. The pulse streams then are sent out to Douglas who uses a fast, optical switch to send and receive a stream to/from Alice before switching the fiber connection to send and receive the corresponding pulse stream from Bob. The polarization state of the return pulse streams has been rotated by the Faraday mirrors at Alice and Bob so when they again reach Charlie, they travel through the opposite arms of the unbalanced interferometer and the two pulse streams are resynchronized. Finally, a circulator is used by Charlie to route the recombined pulse streams to his Bell state analyzer. Circulators are nonreciprocal optical elements (like Faraday mirrors). The light passes from 1 to 2 on the outgoing pulse and from 2 to 3 for the incoming pulse (this is what the clockwise arrow represents). It is a standard component for using a single fiber for 2-way communication. It is also very difficult or impossible to implement on a PIC. Charlie's system is somewhat more complex in this arrangement, but Douglas' system is extremely simple, and we also retain the plug-and-play simplicity for Alice and Bob.

FIG. 22 illustrates a MDI-QKD, plug-and-play design where Charlie generates the short time delay between pulses for Alice and Bob and then delays Alice's (or Bob's) pulse stream by a long enough time that all of Bob's (or Alice's) pulses are sent first, followed by the other pulse stream. Douglas' node is now simply a fiber switch that routes the appropriate bit stream to the proper receiver.

The light polarization for the beams to Alice and Bob as they move through this system are given in Table 5. The probability of photon detection at Charlie's single photon detectors depends on the basis and specific state chosen by Alice and Bob is shown in Table 4 for single photons from Alice and Bob and ideal optics. A detailed discussion of the detection probability for multi-photon emission and nonideal detectors is given in the appendix pursuant to calculating the practical key generation rate.

TABLE 5
Light polarization along optical path.

| | Polarization of | |
|---|---|---|
| | pulse along | |
| | path to and | Polarization of pulse along |
| | from Alice (at | path to and from Bob (at |
| Component in FIG. 1A8 | component) | component) |
| Laser | V | V |
| intensity mod. | V | V |
| HWP in Bob′s optical | not applicable | H |
| path at Charlie | | |
| NPBS, entering | V | H |
| Faraday mirrors | H | V |
| NPBS, exiting | H | V |
| Circulator | H | V |
| PBS, entering | H | V |
| Faraday mirror | V | H |
| PBS, exiting | V | H |
| Douglas switch | arbitrary | arbitrary |
| Attenuator | arbitrary | arbitrary |
| intensity modulator | arbitrary | arbitrary |
| phase modulator | arbitrary | arbitrary |
| Faraday mirror | rotated 90° | rotated 90° |
| phase modulator | arbitrary | arbitrary |
| intensity modulator | arbitrary | arbitrary |
| Attenuator | arbitrary | arbitrary |
| Douglas switch | arbitrary | arbitrary |
| PBS, entering | H | V |
| Faraday mirror | V | H |
| PBS, exiting | V | H |
| Circulator | V | H |
| PBS | V | H |
| HWP | V | V |
| BS | V | V |
| SPDs | V | V |

This table exhibits how the polarization state of the two photon pulses for Alice and Bob vary throughout the entire optical system including Charlie. However, because of the birefringence in the fiber channel, the polarization state is only well-defined at Charlie.

As an example of the connection between the hardware and the network configuration, the hardware components in FIG. 22 are listed in the first column of Table 6 and the corresponding location for the component in the YANG module which is under development for this project in the following three columns. The YANG modules are being developed as part of the IEEE P1913 working group in order to encourage compatibility across all vendor QKD products. YANG module development is a deliverable for Task 5 of this project and the modules are available upon request. Note that these are still draft modules in IEEE P1913 and subject to change as the standard develops.

TABLE 6
YANG module components to implement MDI-QKD design on
the network

| | | | YANG | Description of YANG |
|---|---|---|---|---|
| | YANG | YANG | container/ | Model Concept of |
| Component | module | grouping | case/leaf | Operation |
| Laser | ieee1913- | | continuous- | Laser on/off |
| | quantum- | | source | Driving current |
| | source- | | | Laser wavelength/ |
| | types@202 | | | temperature |
| | 0-07- | | | |
| | 28.yang | | | |
| Nonpolarizing | ieee1913- | beamsplitter | nonpolarizing | Passive device, |
| BS | passive- | | | description only |
| | optics@20 | | | |
| | 20-08- | | | |
| | 14.yang | | | |
| Intensity | ieee1913- | attenuator | electronic | Charlie's IM used to |
| modulator | fiber- | | | shape the CW light |
| | optics- | | | from the laser into a |
| | attenuator | | | short pulse: one for |
| | @2020-08- | | | Alice pulses and one |
| | 19.yang | | | for Bob pulses |
| | | | | Also used to adjust |
| | | | | intensity of pulses so |
| | | | | that regardless of the |
| | | | | distance of Alice and |
| | | | | Bob from Charlie, |
| | | | | they both receive |
| | | | | enough photons to |
| | | | | attenuate |
| | | | | appropriately and |
| | | | | send back to Charlie |
| Half wave | ieee1913- | waveplates | quartz- | Passive device, |
| plate | passive- | | achromatic | description only |
| | optics@20 | | | |
| | 20-08- | | | |
| | 14.yang | | | |
| Polarizing BS | ieee1913- | beamsplitter | Polarizing | Passive device, |
| | passive- | | | description only |
| | optics@20 | | | |
| | 20-08- | | | |
| | 14.yang | | | |
| Fiber | ieee1913- | fiber | | Passive device, |
| | fiber- | | | description only |
| | optics- | | | |
| | fiber@202 | | | |
| | 0-08- | | | |
| | 19.yang | | | |
| Faraday mirror | ieee1913- | faraday- | | Passive device, |
| | passive- | mirror | | description only |
| | optics@20 | | | |
| | 20-08- | | | |
| | 14.yang | | | |
| Circulator | ieee1913- | circulator | Circulator | Passive device, |
| | passive- | | | description only |
| | optics@20 | | | |
| | 20-08- | | | |
| | 14.yang | | | |
| Single-photon | ieee1913- | discrete- | | Bias current or |
| detector | quantum- | variable- | | voltage |
| | receiver- | group | | Temperature |
| | types@202 | | | Threshold voltage |
| | 0-05- | | | Timing |
| | 28.yang | | | Others listed in |
| | | | | YANG module |
| Fiber switch | ieee1913- | coupler- | | Set input and output |
| | fiber- | splitter | | ports at appropriate |
| | optics- | | | times to pass photons |
| | coupler- | | | |
| | splitter@20 | | | |
| | 20-08- | | | |
| | 19.yang | | | |
| Variable | ieee1913- | attenuator | Electronic | Adjust intensity of |
| attenuator | fiber- | | | pulses so that double |
| | optics- | | | pulse has the same |
| | attenuator | | | average photon |
| | @2020-08- | | | number as single |
| | 19.yang | | | pulse, and decoy and |
| | | | | signal states have |
| | | | | desired average |
| | | | | photon numbers. |
| | | | | Note: this has to be |
| | | | | set up in conjunction |
| | | | | with Charlie. Charlie |
| | | | | will send a bright |
| | | | | pulse initially and |
| | | | | Alice and Bob will |
| | | | | need to adjust their |
| | | | | attenuation levels for |
| | | | | signal and decoys |
| | | | | states in each basis. |
| Phase | ieee1913- | phase- | | Control phase shift |
| modulator | fiber- | modulator | | between pulses |
| | optics- | | | |
| | phase- | | | |
| | modulator | | | |
| | @2020-08- | | | |
| | 19.yang | | | |
| Fiber coupler | ieee1913- | lens | Aspheric | Passive device, |
| (lens) | passive- | | | description only |
| | optics@20 | | | |
| | 20-08- | | | |
| | 14.yang | | | |
| Basis | ieee1913- | basis-types | time-bin, | Basis selection from |
| representation | photon- | | phase-shift | RNG |
| | encoding- | | | |
| | types@202 | | | |
| | 0-07- | | | |
| | 29.yang | | | |
| Coincidence | ieee1913- | | | Timing electronics to |
| counter | coincidence- | | | detect the psi-minus |
| | counter- | | | state |
| | types@202 | | | |
| | 0-07- | | | |
| | 28.yang | | | |
| Classical | ieee1913- | | | Management and |
| processing | mdi-qkd- | | | monitoring of |
| | classical- | | | Charlie's |
| | processing | | | communication to |
| | @2020-09- | | | Alice and Bob as well |
| | 14.yang | | | as the exchange of |
| | | | | information between |
| | | | | Alice and Bob. |
| Time | ietf- | | | TSN time- |
| synchronization | gptp@2018- | | | synchronization |
| | 03-28.yang | | | |
| Optical | ieee1913- | | Example: | ietf-network- |
| topology | passive- | | augment | topology.yang is |
| | optical- | | “/nw:networks/ | augmented with |
| | topology@ | | nw:network/ | specific optical |
| | 2020-08- | | nw:node” { | components (nodes |
| | 08.yang | | when | and links) in this table |
| | | | “ . . . /nw: | to model the optical |
| | | | network- | circuit. |
| | | | types/pot: | |
| | | | quantum-circuit- | |
| | | | topology” { | |
| | | | description | |
| | | | “Augmentation | |
| | | | parameters | |
| | | | apply only | |
| | | | for quantum | |
| | | | circuit | |
| | | | topology.”; | |
| | | | } | |
| | | | . . . | |
| | | | } | |
| Time-sensitive | https:// | | This is a | Optical paths and |
| networking | github.com/ | | suite of | switches (Douglas |
| (TSN) | YangModels/ | | YANG | switches described |
| | yang/tree/ | | modules | later) are controlled to |
| | master/ | | commonly | enable the correct pair |
| | standard/ieee/ | | used to | of Alice and Bob |
| | published/ | | configure | nodes to achieve |
| | 802.1 | | and control | photon coincidences |
| | | | TSN. | at Charlie. |

Returning to alternate approaches to enable intermediate switching and routing between edge devices and Charlie's node for which there is only one optical fiber path:

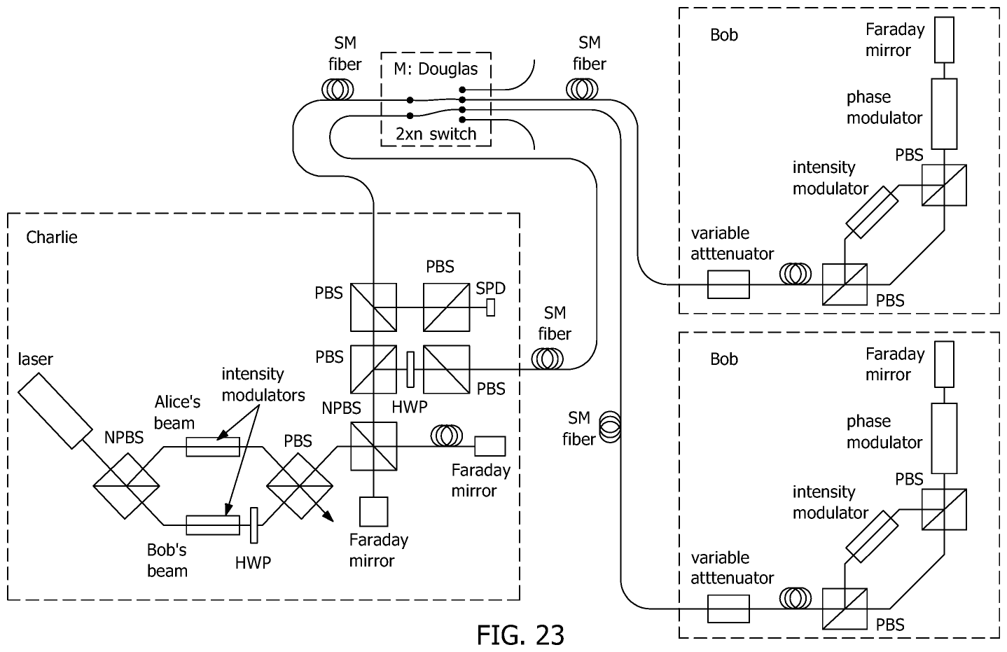

4) The simplest solution is to require two or more quantum fiber pathways between M₁ and N₁. This redundant pathway may already be incorporated in a QKD network for reliability. Then the TSN scheduler ensures that the photon pulses sent and received to/from Alice and Bob follow the different pathways. As shown in FIG. 23, Douglas' setup becomes particularly simple, just a 2×n optical switch (H. Lee, T. Chen, J. Li, O. Painter and K. J. Vahala, “Ultra-low-loss optical delay line on a silicon chip,” Nat. Commun. 3 (2012) 867) that passes the photon pulses from the appropriate input fiber to the appropriate edge devices. However, the big disadvantage is the need for two separate fiber pathways between Charlie and Douglas.

FIG. 23 illustrates a “brute force” plug-and-play MDI-QKD arrangement incorporating two separate fiber pathways between Charlie and Douglas. Douglas' node is simply a 2×n optical switch that ensures the two inputs/outputs from Charlie are connected to the two proper edge devices.

Four different options for locating the expensive equipment, or at least the detectors, at the Charlie nodes have been discussed. Of these options, it would seem that the arrangement in FIG. 20 may be the best as it can make use of any existing conventional SM optical fiber network, does not need to locate extra components at Douglas nodes, and does not require two separate fibers or polarization maintaining fiber between Charlie and Douglas. The primary disadvantage of this approach is that it reduces the key generation rate by half as the two pulse trains must be sent sequentially. These four approaches incorporate additional equipment into the nodes and/or network like PM fiber, circulators, PBS's, and other components which must be weighed against the expense and convenience of making every orange M node into a full-fledged Charlie node.

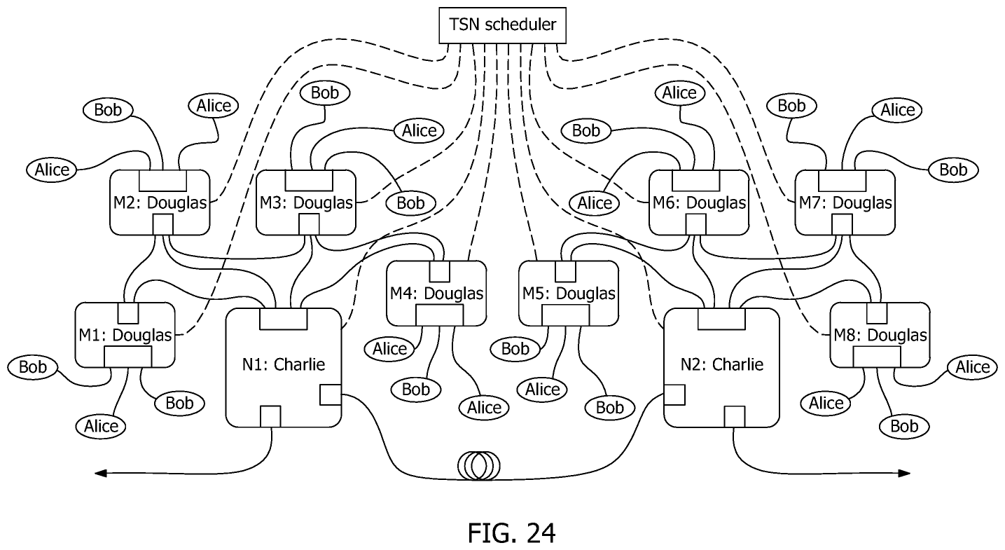

Putting this all together with the TSN scheduler, the TS-QKD network configuration could look something like that in FIG. 24 in which there is only one Charlie node per metropolitan region which is outfitted with expensive components such as cryogenic detectors and the ability to communicate over long distances with other Charlie nodes via quantum channels. Indeed, the distance advantage of MDI-QKD can be employed by using an intermediate Charlie node between two other Charlie nodes to generate a random key between the two outer Charlie nodes. The Charlie nodes must of course contain the appropriate time-bin/phase shift optics like those at Alice and Bob in order to communicate in this manner. Each Charlie node is connected to Douglas substations which in turn are connected to multiple edge devices. The Douglas substations may also be connected to other Douglas substations to provide redundant fiber pathways, and the Charlie nodes are likewise connected to multiple Charlie nodes in other metropolitan areas. The TSN scheduler must be connected to the Charlie and Douglas nodes though not necessarily to the edge nodes. The edge nodes are continuously listening for communications from the Douglas node to which they are connected. When a bright timing pulse is received from Douglas to initiate a QKD key generation, the edge device is then primed for subsequent time-bin/phase shift modulation of arriving QKD photons. To send an alert or to request a new key, the edge device initiates a nonscheduled data transfer which may occur over the classical (unsecure) channel. To do this, however, it must use a previously stored key for authentication. A new key can then be generated for follow-up communication.

FIG. 24 illustrates a TS-QKD network diagram. Charlie nodes N₁, N₂, . . . are located at metropolitan central stations. They are connected to Douglas nodes M₁, M₂, . . . at substations, which in turn are connected to the edge devices. The TSN scheduler must be connected to the Douglas and Charlie nodes but not necessarily to the edge devices.

### 7. Controlling Simultaneity in a Communication Network

Returning to a viable P&P MDI-QKD design such as that shown in FIG. 18 based on time-bin and phase encoding, we now consider how this technique may be integrated with TSN. As previously described, this QKD technique places all the expensive, power hungry equipment including the light source and detectors at Charlie's untrusted node. This node may be one of the stations in FIG. 5 that is connected to multiple edge devices or a control center that is connected to multiple stations. Ideally there are very few of these Charlie nodes on the network due to their complexity, expense, and required routine maintenance. The P&P MDI-QKD approach in FIG. 18 also automatically solves the problem of laser wavelength control. The laser source can be a low-cost distributed feedback (DFB) laser diode which is temperature controlled to maintain a fixed wavelength over the time interval corresponding to the difference in arrival times of the photons from Alice and Bob. For example, if fiber length from Charlie to Alice is 10 km longer than the length from Charlie to Bob, this corresponds to a time difference for photon travel of ˜50 microseconds or round-trip 100 microseconds. As long as Charlie's laser temperature/wavelength remains sufficiently constant over this very short time interval to within the bandwidth of the laser line, the photons from Alice and Bob will be indistinguishable in wavelength after returning to Charlie's system. By using Faraday mirrors and a time-bin/phase encoding technique, we also ensure that distinguishability between the two photons from the polarization effects of the fiber birefringence is eliminated. The only remaining issue that must be addressed is the requirement that Alice's and Bob's photon return to Charlie's NPBS “at the same instant.” In other words, the photons pulses from Alice and Bob must overlap when they arrive at the beamsplitter. For example, in R. Won, “Integrated solution for quantum technologies,” Nat. Phot. 13 (2019) 77-79, the laser pulses are synchronized to with 10 ps for pulses that are 2 ns in length which guarantees a high interference visibility. This is where the TSN scheduler can make a key contribution.

Before discussing an invention for synchronizing events enabling MDI-QKD, it should be recognized that there are a plurality of quantum network algorithms and protocols that require the ability to configure the network in preparation for simultaneous events and to determine whether those events indeed happened simultaneously. Examples include but are not limited to, Superdense Coding, various QKD protocols, and in general, numerous network entanglement-based protocols.

The quantum network can be conceptually divided into a data plane, which is the conceptual model of paths and supporting equipment over which the main communication traffic flows, and the control plane, which is the conceptual model of paths and equipment over which the network is configured and controlled. The data plane comprises single-photon and entangled-photon transport and manipulation. The control plane comprises classical, remote configuration and operation of the data plane.

A network configurator (NC), or alternatively, centralized network configurator (CNC), manages and controls the entire network. The CNC has complete information about network topology. Topology information can be manually entered or every device on the network (end-systems and switches) reports information about its immediately adjacent connections (neighbors) enabling the entire interconnectivity of the network to be discovered by the CNC. This includes both classical (e.g., Ethernet or wireless) devices and connections as well as quantum optical devices and connections. This is defined for classical systems for the IEEE802.1 standard (G-Z. Tang, S-H. Sun, F. Xu, H. Chen, C-Y. Li and L-M. Liang, “Experimental asymmetric plug-and-play measurement-device-independent quantum key distribution,” Phys. Rev. A 94 (2016) 032326). We assume that the quantum channels will be likewise advertised via this classical protocol. That is, every QKD component will also be connected to a classical network, which will also report it's optical and quantum connections to nearest neighbors. The CNC uses QKD-generated keys to authenticate and encrypt communication with all network devices.

For the classical control plane, the maximum size of every message is known, a priori, by the CNC, where message size is used to compute message transmission time. For the quantum data plane, a single-photon message size is simply the duration of time between the request for transmission of a single photon and the time the photon is actually emitted by the device. Note that for a classical system, this can be known with a high degree of determinism, but for a quantum system, a Poisson mean value may be the most that can be determined.

The propagation delay along every link is also known a priori, inferred either via cable length or via a variety of means that involve echoing a small message from adjacent neighbors. We also assume the CNC can query optical components within the network for the single-photon propagation delay of quantum fiber channels.

A separate time synchronization protocol, for example, one of the many profiles (variants) of Precision Time Protocol (PTP), known as gPTP (https://github.com/YangModels/yang/blob/master/standard/ieee/draft/802.1/ABcu/ieee8 02-dot1ab-lldp.yang), maintains clock synchronization throughout the entire network. This is accomplished by ensuring network interfaces support hardware timestamping, enabling accurate and precise timestamps that are placed in short messages exchanged in order to measure link delay. Timestamping is done within the hardware as close to the “wire”, e.g. the physical link, as possible to ensure no jitter or delay occurs from anything other than propagation time over the link. Typically, messages are sent and returned with appropriate timestamps allowing the device initiating the propagation delay measurement to divide by two assuming the link is symmetric. Propagation delay measurements are performed periodically to ensure up-to-date results.

Once link propagation delays are known, synchronization messages are exchanged that contain the current clock tick rate. A clock is identified as a grandmaster clock and all other clocks adjust their tick rate ratio such that their time matches the grandmaster's notion of time. Since clocks are clearly defined relative to one another in a master-slave relationship forming a spanning tree, clock rates are adjusted relative to one another such they all match the grandmaster clock. Put another way, grandmaster time can be reconstructed by every clock in the network. There is always error, however small, typically measured in root mean square (RMS) nanoseconds. Error is dependent upon the stability of the clocks, how often the synchronization messages are sent, and in a large network, on placement of the grandmaster within the network topology relative to the other clocks. All PTP message exchanges are authenticated and encrypted using QKD-generated keys.

At this point, the network is time synchronized, and the CNC knows all message sizes, the network topology, and all link propagation delays. The CNC also knows the source and destination of all messages in the network, including all classical control messages and all quantum data plane messages. If the CNC is provided with the maximum-tolerated latencies for each pair of end-systems that need to communicate, the CNC can determine a single-photon path and schedule when each device along the path should transmit the photon. The CNC must compute initial transmission (photon emission) and periodic opening and closing times of gates (switches) for each device along a network path such that messages are sent and received at precise, periodic intervals forming a connected path while simultaneously avoiding collision within the network. Collision occurs when transmitting more than one message at the same time (such that the photons, in this case, would overlap) over the same link. However, as mentioned, there are quantum networking algorithms where the goal is to create a perfect collision, namely a simultaneous event where two messages (single photons) arrive at the same location at the same time. And the goal is to accomplish this simultaneous event periodically. Although this is something a network scheduler typically seeks to avoid, it is an interesting task to add to the scheduler's capabilities. This is accomplished using TSN via the following steps: (1) identify specific Alice and Bob devices and label them as TSN Talkers within the CNC scheduler (2) identify the Charlie device and label it as a TSN Listener in the CNC scheduler (3) set the maximum TSN latency for the Talker-Listener flows to be the longer of the Alice-Charlie and Bob-Charlie optical propagation delay times (4) compute the TSN schedule, which results in a periodic cycle time with offsets within the cycle for the Alice and Bob nodes to transmit. It should be noted in step (3) that the maximum flow latency must be computed such that messages arrive at precisely the same time and rather than any time less than the maximum. This requires a change to the typical TSN scheduler solver.

In a classical setting, the CNC attempts to meet or exceed the required minimum latencies for each deterministic flow. This can be tightened to provide exact latencies. Also note, that in a strictly classical Ethernet setting, the CNC is controlling the flow of a classical data plane. However, the control plane can remain classical, while the data plane is quantum. The CNC can send configuration information to configure known, deterministic paths through the quantum data plane at precisely periodic time intervals. Typically, this would be done via a YANG module that exposes network configuration and control information about a device in a well-described manner. The CNC would have to either manually be provided with the required quantum channel paths or be able to query and learn about the quantum network via something like NETCONG/YANG or Link Layer Discovery Protocol (LLDP) and infer when specific quantum channel paths are required. For example, if the CNC were provided with the fact that certain network devices identified themselves as Alice, Bob, or Charlie and the duration of time connections are required among Alice, Bob, and Charlie, then the CNC computes and configures such connectivity for the entire network. The CNC makes the decision as to which Alice, Bob, and Charlie combinations are optimal for the network, depending upon their locations, capabilities, and QKD key consumption requirements within the network.

Since the network is time synchronized, the CNC can also provide to Alice and Bob meaningful information about whether, and precisely when, a coincidence event happened at Charlie and serve to provide additional support and verification of events necessary for MDI-QKD.

There exist numerous scheduling algorithms that can be used by the CNC.

If Alice and Bob are edge devices that are part of a TSN network, then the “node” e.g. Alice, Bob, or Charlie, MUST have a network clock. Each network output port has its own clock in TSN to control the gates. All clocks on the device are synced to network time. The QKD chip can use this clock for timing. Alice and Bob use timing, for example, to modulate the pulses from Charlie, determining which pulses to shutter or pass, which pulses to phase shift or not phase shift, and which pulses are decoy states that have a different average number of photons.

Another interesting difference between classical use of the CNC and this invention is that classically, the CNC computes a single cycle time with offsets indicating when each network event occurs, and this cycle time and these offsets remain constant over many cycles. In this invention, propagation delays may need to be updated more often due to sensitivity of fiber length on propagation delay. It is recognized that re-computation should only be done when propagation delay changes are significant enough to warrant a re-computation. This could be determined, for example, by a noticeable drop in the key production rate. It should also be noted that the CNC is now controlling things like coincidence detection windows and photon detector gating as well as network switches and classical Qbv gate control.

The CNC can indicate when Charlie is to send his initial calibration pulse to both Alice and Bob and configure the network switches such that the pulse travels to Alice and Bob and back to Charlie so that Charlie can then determine the correct time delay, report that back to the CNC, and the CNC can tell Charlie again when to send his QKD pulse sequence to Alice and when to send it to Bob, while ensuring that the appropriate network path/switches are selected.

Alternatively, if Alice's, Bob's, and Charlie's clocks are perfectly synchronized, then Alice and Bob only need to timestamp when they received Charlie's pulse, and report that to the CNC, and Charlie only needs to report to the CNC when he sent the pulse. Then the CNC can tell Charlie when to send his QKD pulses to Alice and Bob and also when to expect the return coincidence. The latter is important because Charlie may need to gate his detectors to just look for the return photon coincidences from Alice and Bob within a narrow time window to eliminate dark count noise from his detectors.

Since Charlie is assumed to be untrusted, careful consideration should be made regarding what capabilities are placed on Charlie. For example, Charlie should not be a grandmaster clock. Finally, there is a chicken-and-egg problem: Charlie is participating in network time synchronization and scheduling, assuming QKD-protected message exchanges, before QKD keys are being generated. One could address this by simply not including Charlie in the time synchronization and scheduling processes, only Alice and Bob (trusted nodes) need to participate in time synchronization and scheduling. However, if Charlie were to attempt to report misleading values, it will fail to create simultaneous events leading to detectable error.

As shown in FIG. 5, a robust communication network includes redundant channels. This means that information packets do not have a fixed, a priori route over which they travel between two parties. The route is determined by the network. In TSN, there is further control. Not only is the route determined, but the timing of various switches and routers along the path is also determined by the TSN scheduler. This is a key advantage for P&P MDI-QKD. When a regularly scheduled communication is to take place between two parties, the TSN scheduler, which may be collocated with Charlie, fixes the route for the communication and first directs Charlie to determine his optical time delay between himself and Alice and Bob by sending a classical (high intensity, many photon) pulse from his QKD laser over the channel along this route. We note that Charlie sends a many photon pulse during the QKD process as well, so this does not require any modification of Charlie's laser pulse intensity. The TSN scheduler ensures that the appropriate switches are open along the route so that the pulse is not intercepted and buffered at any switch. Alice and Bob simply reflect the pulse back to Charlie along the same route. In other words, they do not attenuate this pulse to single photon levels like they would normally do during the QKD process, but they still use Faraday mirrors to reflect the pulse so that time delays from fiber birefringence are also included in exactly the same manner as during the QKD process. Charlie still must distinguish between return pulses from Alice and Bob. If the return pulses are polarized identically, as they are for the P&P MDI-QKD system in FIG. 1A0, then Charlie may have to insert another splitter in the return path for Alice and Bob to detect each return pulse separately. Because these are relatively bright pulses, the splitters do not have to split off much light to separate conventional photodetectors. Alternatively, in schemes in which the return pulses arrive oppositely polarized, because they will inevitably arrive at different times, they may be easily distinguishable and identifiable at the single photon detectors. Detecting the pulses with the built-in single photon detectors has the advantage of automatically including timing delays from the detector electronics, but it likely in this case that Alice and Bob will still need to attenuate their return pulses, so they do not saturate the detectors. Instead of a single pulse, Bob may also send a pulse sequence to Alice and Bob to provide better timing information from weak return pulses.

Charlie notes the time difference between his detection of the two pulses and communicates this to the TSN scheduler if necessary. The TSN scheduler then selects the same route and opens the channel for the QKD key distribution to Alice and Bob at the appropriate instants (which may be different depending on the time delay required). Charlie now knows the delay he must use between the photon he sends to Alice and the one he sends to Bob so that the reflected photons arrive at his NPBS at the same instant. When triggered by the TSN scheduler, he then sends his sequence of pulses to both Alice and Bob with the appropriate delay. The TSN scheduler can set up this time calibration routine as frequently as required so that the slow drifts in the speed of light over fiber that are occurring constantly do not affect the quantum key distribution.

### 8. Proposed Chip Designs For MDI-QKD With Plug-and-Play

A basic photonic integrated circuit chip design that operates at telecom wavelengths (typically 1550 nm) is shown in FIG. 3 that enables the operation of the Alice and Bob nodes in the MDI-QKD plug-and-play design in FIG. 18. Only the photonic components are shown though other components for generating random signals, controlling the optical components, and computing the key could also be included in the chip or total system package. Our approach is to show integration of optics with the network. Electronics is a shim to be added later. We need to understand the higher-level, e.g. network system operation of the optical implementation first. There are ten electrical pads on the chip to control the variable attenuator, the intensity modulator, and the phase shifter as well as to monitor the two photodetectors for bright light attacks. These components are, for the most part, standard in PIC fab PDKs. Thermal phase shifters, which are common PDK components, respond too slowly for this application. However, electrically controlled phase shifters have also been designed for PICs (https://1.ieee802.org/tsn/802-1as-rev/; D. J. Thomson, et al., “High contrast 40 Gbitds/s optical modulation in silicon,” Opt. Exp. 19 (2011) 11507; K. Goi et al., “Silicon Mach-Zehnder modulator using low-loss phase shifter with bottom PN junction formed by restricted-depth doping,” IEICE Electron. Exp. 10 (2013) 20130552; R. Maram, S. Kaushal, J. Azana and L. R. Chan, “Recent trends and advances of silicon-based integrated microwave photonics,” Photonics 6 (2019) 13). Also, it may be important to include a narrowband optical filter either at the entrance waveguide on the chip or at the end of the fiber that connects to the chip to only allow the correct light wavelength to interact with the chip components in order to protect against Trojan horse attacks from Eve at other wavelengths that attempt to monitor the phase state of the phase shifter, for example.

The red arrows indicate the light path for a vertically polarized photon from the fiber which enters the chip with TM polarization, is rotated to TE polarization, and follows a clockwise path around the chip. It first encounters a 90:10 tap which sends some of the incident light to an analog (usually germanium) photodetector to sense for bright light attacks. The rest of the light continues around the loop through a variable optical attenuator that reduces the light level so that during key generation it is unlikely to emit more than one photon, an intensity modulator for adjusting the average number of photons between the key level and the decoy level(s), and a phase shifter to randomly modulate the photon phase by either 0 or π. The photon returns to the polarizing beamsplitter where it is out-coupled into the fiber as horizontally polarized light.

If the incident photon is horizontally polarized, it enters the waveguide as TE polarization, follows a counter-clockwise optical path, going first to a second 90:10 tap and photodetector to sense for a bright light attack, and then through the remaining components in reverse order (order does not matter). The photon is then coupled back into the waveguide through a polarization rotator which converts it to TM polarization before reentering the fiber with vertical polarization. (TE & TM are orthogonal polarization states in waveguides, just like H and V are for free space. There is no interference between these two waveguide modes in linear media.) A bit stream from Charlie is passing through A & B sequentially. Because the waveguide path length is so short on the chip, there will only be one pulse in the chip at any time. Hence, Alice and Bob must be able to switch their modulators fast enough to operate on the individual pulses.

Generally, it is desirable to maintain TE polarization in the PIC, because the electric field for the TM waveguide mode extends further into the cladding and can interact with the Si substrate. Therefore, the TM mode is typically attenuated much more than the TE mode. However, as Alice's and Bob's nodes both contain attenuators anyway to reduce the reflected photon count to less than one, it is not critical that the chip be designed for TE mode. On the other hand, most of the components in the process development kit (PDK) for a typical CMOS PIC foundry are designed and optimized for TE mode. Furthermore, birefringence in the fiber will be constantly changing the polarization state at the input coupler to the PIC. However, it is not desirable to have the amount of photon attenuation change over time as the amount of input light in each polarization state changes. Therefore, by converting the input light regardless of polarization to TE mode, the light attenuation on the chip should remain relatively constant.

FIG. 3 illustrates a layout of P&P MDI-QKD system for either Alice or Bob in an integrated photonic chip. Some typical dimensions are exhibited for these chip components, but the drawing is not to scale. The waveguide is shown with various optical components inserted along the waveguide path. Electrical pads for controlling the components are rectangles. The arrows picture an incident vertically polarized photon which couples into the TM waveguide mode. It gets converted to a TE waveguide mode and exits the chip horizontally polarized. An incident horizontally polarized photon would pass through the chip in the counterclockwise manner and exit as vertically polarized after passing through the polarization rotator. In general, regardless of input polarization, the output photon receives the same phase shift and attenuation but exits in the orthogonal polarization. This has the same effect as a Faraday rotator. However, TM mode propagation on a Si chip is very lossy, so the extent of the waveguide for which the light is propagating in a TM mode is typically minimized.

More fundamentally, the photons reaching Alice and Bob are in an arbitrary polarization state due to the fiber birefringence. Therefore, the PBS will split the beam, some light going left and some going right. Both parts of the beam are phase shifted and attenuated (since the phase shifters and attenuators don't care which way the light passes through them) and then are recombined with the opposite polarization state before being returned to Bob. Whichever path the incoming photon decides to follow, its arbitrary polarization state gets rotated by 90 degrees and is then returned to Charlie. The birefringence in the fiber then “undoes” the randomness it generated on the way out so that by the time the photon reaches Charlie, it is returned to linear polarization but rotated by degrees.

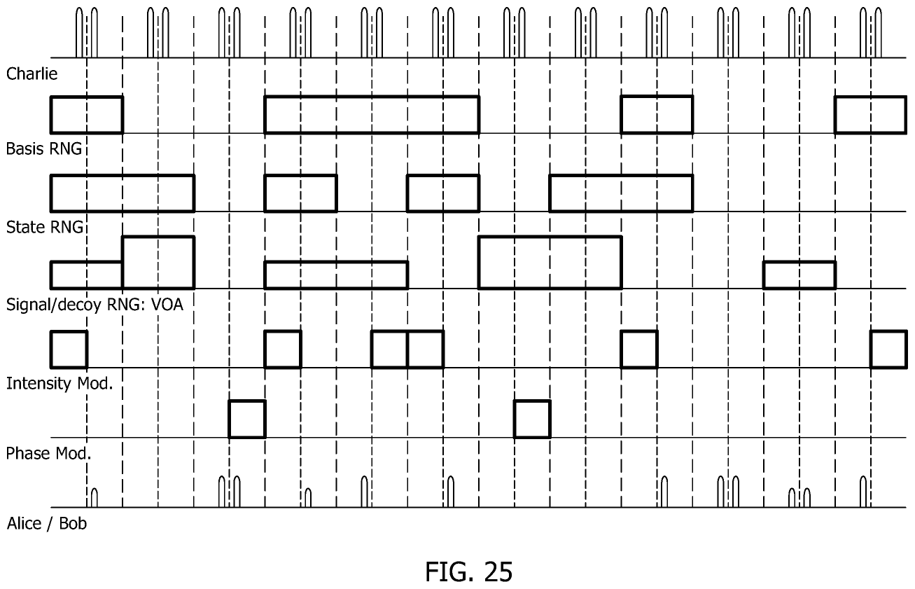

A timing diagram that shows how the chip modulates the intensities and phases of the return pulses is shown in FIG. 25. There are modulation patterns that must be random, the basis selection, the specific basis state, and the photon level. These random patterns control the intensity modulator, the phase modulator and the variable optical attenuator as shown in the timing diagram.

FIG. 25 illustrates a timing diagram. Recall that Z-basis is comprised of 1st or 2nd time bin only and the X-basis is comprised of both time-bins but zero or pi phase shift between them. Charlie sends dual many-photon pulses to Alice and Bob. The smaller dashed lines separate pulse pairs (bits). The larger dashed lines separate the pulses in each pair. Alice and Bob use RNGs to determine whether to modulate the pulses in the time-bin basis or the phase shift basis. There is only one pulse in the Z basis (1st or 2nd time-bin) and two pulses in the X-basis with a phase shift between them. They also use RNGs to determine the specific state of the return pulse in each basis. If the time-bin basis is selected and the first pulse is selected to be blocked, to implement Z basis i.e. time-bin, then the resulting photon pulse emitted by Alice or Bob is only in the second time-bin. height of box in some sense relates to voltage applied, either on or off in this case, but in one case there are three voltage levels. If the basis selector is low, then the phase shift basis is chosen. If the state level is high then a p phase shift is inserted between pulses (represented in the bottom chart by a pulse pair) but if the state level is low then there is no phase shift between the pair. The average number of photons is adjusted by the VOA based on another RNG to the signal, decoy, or vacuum level. A high level attenuates the pulses to the vacuum state (no return photons from Alice or Bob). An intermediate level attenuates to the decoy state, and a zero level returns photons in the signal state average photon level. Alice/Bob variation in bar height represents attenuation level for signal/decoy/vacuum states.

Because of the polarizing beamsplitter/polarization rotator (PBS/PR) combination at the entrance of the chip, the returning photon has had its x/y polarization components interchanged as occurs in a Faraday mirror so after the photon returns to Charlie through the fiber cable, the effect of birefringence is eliminated. This is a critical feature of plug-and-play systems that enables the birefringence in the fiber to be neglected. When the photon reaches Charlie's apparatus as shown in FIG. 18, because its polarization has been rotated by 90°, a PBS now redirects the photon to the Bell state measurement detectors. The remainder of the QKD system is the same as that described in F. Xu, “Measurement-device-independent quantum communication with an untrusted source,” Phys. Rev. A 92 (2015) 012333.

### 9. Key Generation Rate

It is interesting to also calculate the key generation rate for the plug-and-play MDI-QKD technique described in the previous section. The derivation of the calculation technique is quite tedious as shown in the appendix. Key generation rates using InGaAs single photon detectors are relatively low compared to higher efficiency SNSPDs due to their much higher background dark count rates and lower detection efficiencies. We can compare the key generation rates as a function of distance for these different detectors. Following the procedure in Z. Yong et al., “U-shaped PN junctions for efficient silicon Mach-Zehnder and microring modulators in the O-band,” Opt. Exp. 25 (2017) 8425, we calculate the key rate for up to three photons (a three-photon Fock state) arriving at Charlie's BS from both Alice and Bob. More fundamentally, Charlie emits billions of photons in his pulses, but Alice and Bob attenuate them to on average ˜0.5 photons/pulse. However, since the actual number of photons remaining in a pulse follows a Poisson distribution, sometimes there will be more than one photon in a pulse and sometimes there will be no photons in a pulse. Even if there are more, by the time they travel back to Charlie most pulses will only have zero or one photon left. Very, very few pulses have more than one photon, so we can safely ignore four or more photons per pulse when we calculate probabilities.

With suitable attenuation of the reflected photons it is very unlikely that more photons than this will arrive at Charlie's BS. The standard key generation rate equation (i.e., the rate per pulse for which signal photons in the |Ψ⁻ [symbol] singlet Bell state detected by Charlie and sifted to have been sent in the same basis by Alice and Bob) is (P. Chan, J. A. Slater, I. Lucio-Martinez, A. Rubenok, and W. Tittel, “Modeling a measurement-device-independent quantum key distribution system,” Opt. Exp. 22 (2014) 12716-12736)

R≥w[Q₁₁^{z}−Q₁₁^{z}H₂(e₁₁^{x})−Q_{μμ}^{z}fₑH₂(e_{μμ}^{z})] (1)

where w is a factor that accounts for the protocol efficiency and number of decoy states, Q₁₁^{z} is the gain in the Z (time-bin) basis, H₂ is the binary Shannon entropy,

H₂(x)=−x Log₂(x)−(1−x)Log₂(1−x), (2)

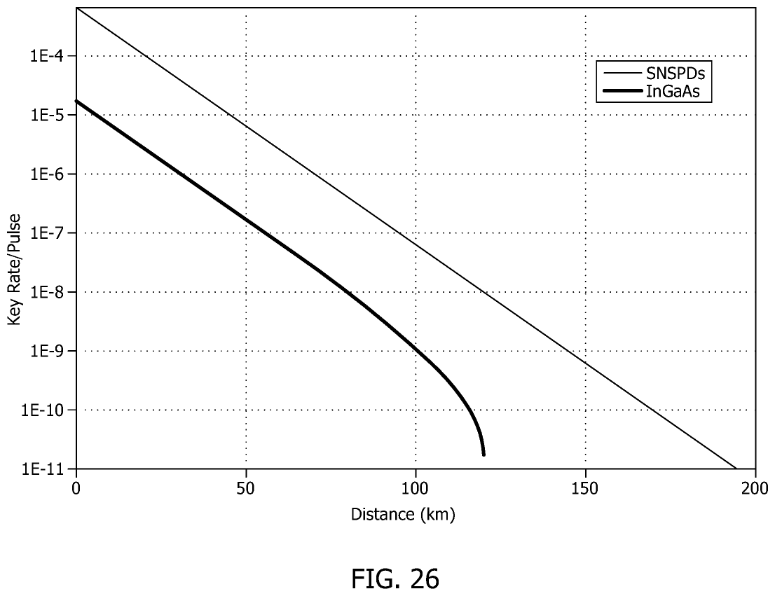

e₁₁^{x} is the error rate in the X (phase shift) basis for single photons emitted by Alice and Bob, Q_{μμ}^{z} is the gain and e_{μμ}^{z} is the error rate in the Z (time-bin) basis when Alice and Bob emit on average m photons per pulse. For the calculations we assume a HOM visibility of 0.99 to account for optical misalignment, μ=0.4 (the average photon level in the signal state), an error correction overhead f_{c}=1.16, and w= 1/18 for pulses evenly divided between a signal level and two decoy levels. The wavelength/detector parameters are listed in Table 7. For the calculation we assume Alice and Bob have detectors with the same characteristics and are located the same distance from Charlie. Calculated key generation rates are shown in FIG. 26.

FIG. 26 illustrates a calculated key rate comparison between SNSPDs and InGaAs SPADs at 1550 nm for the parameters in Table 7.

At all distances the SNSPDs provide the highest key generation rates as expected. If Charlie emits pulses at 50 MHz, for instance, then key bits can be generated at tens of thousands per second for short distances. With InGaAs SPADs the key generation rate drops to just shy of 1 kbit/s, which is still quite reasonable for this proposed power grid application. With the SNSPDs, key rates of ˜50 bits/s can still be generated up to ˜70 km distances between Alice (or Bob) and Charlie.

TABLE 7
Key rate parameters

| Parameter | InGaAs SPADS | | SNSPDs | |
|---|---|---|---|---|
| Wavelength | 1550 | nm | 1550 | nm |
| Fiber loss | 0.2 | dB/km | 0.2 | dB/km |

| | | |
|---|---|---|
| Detector efficiency | 0.15 | 0.9 |
| Dark counts/pulse | 6 × 10⁻⁶ | 2 × 10⁻⁷ |
| (2 ns pulse width) | | |
| Signal level | 0.4 | 0.4 |
| (photons/pulse) | | |
| HOM visibility | 0.99 | 0.99 |

### 10. Chip Enhancements

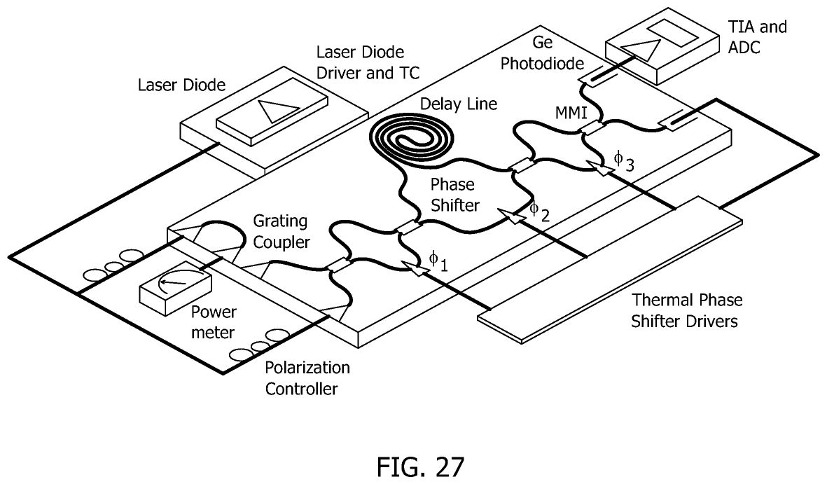

A basic QKD chip design is shown in FIG. 3. However, an actual QKD PIC chip could incorporate some additional components. The intensity modulator that randomly selects time-bins and the phase shifter that randomly adjusts photon phase require a random number generator (RNG). There are a variety of methods for generating random numbers on a chip. Intel has a design that makes use of Johnson noise from a resistor (https://42xtjqm0qj0382ac91ye9exr-wpengine.netdna-ssl.com/wp-content/uploads/2015/08/IntelRNG.pdf). RNGs have also been designed for PICs (F. Raffaelli et al., “Generation of random numbers by measuring phase fluctuations from a laser diode with a silicon-on-insulator chip,” Opt. Exp. 26 (2018) 19730-19741; K. Ugajin et al., “Real-time fast physical random number generator with a photonic integrated circuit,” Opt. Exp. 25 (2017) 6511-6523). In fact, while RNG's based on thermal noise have reached hundreds of Mb/s, making use of chaotic lasers has increased RNG rates to Gb/s. As an example, the chip design in https://github.com/YangModels/yang/blob/master/standard/ieee/draft/802.1/ABcu/ieee80 2-dot1ab-lldp.yang is shown in FIG. 27.

FIG. 27 illustrates a design of random number generator for a PIC chip. The laser is external to the PIC and is temperature-stabilized. Phase fluctuations of the laser are converted into intensity fluctuations by the center MZI with the delay line. The intensity fluctuations are detected and digitized to generate a random number sequence. Notations are MMI: multimode interferometer, TIA: time interval analyzer, ADC: analog-to-digital converter.

There are a variety of other approaches to RNG including amplified spontaneous noise (K. Ugajin et al., “Real-time fast physical random number generator with a photonic integrated circuit,” Opt. Exp. 25 (2017) 6511-6523) and quantum noise (C. R. S. Williams, J. C. Salevan, X. Li, R. Roy, and T. E. Murphy, “Fast physical random number generator using amplified spontaneous emission,” Opt. Exp. 18 (2010) 23584-23590). Obviously, incorporating the RNG on the same chip as the QKD device reduces part count, cost, and enhances security, but the thermal noise approach to RNG is probably suitable and simpler for the low key rates required by most edge devices.

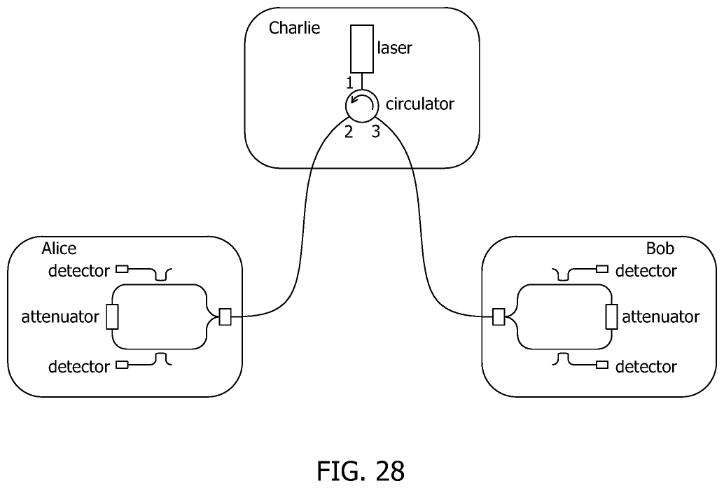

The plug-and-play concept eliminates the light source from the end nodes, Alice and Bob. Yet, Alice and Bob still need to communicate with each other in some manner after generating the key. If we would like to keep lasers for classical communication off of the PIC chips to simplify chip integration, then either there is a laser source off-chip at Alice and Bob that can be coupled through the chip (with attendant losses) for modulation, or the laser can be located at Charlie. Charlie could generate a CW light source either at the same wavelength as the QKD key generation system, or by using wavelength division multiplexing use a different telecom band wavelength. He sends the classical laser light to either Alice or Bob or both, who then use their attenuators to modulate the beam and return it to Charlie. A circulator then routes the encrypted return beam to the other party for communication as shown in FIG. 28.

FIG. 28 illustrates a technique to enable Alice and Bob to communicate with each other using a laser beam generated by Charlie.

Charlie could also split-off part of the return beams from Alice and Charlie to monitor for transmission directed to him, i.e., if either Alice or Bob wants to initiate key generation or communication with another party. Of course, this wastes bandwidth to have Charlie continuously sending a CW laser beam to each edge device which might need to initiate communication. Charlie could also intermittently send a beam to every edge device to see if that device wanted to communicate. If a new edge device is added to the network, then there must be a means to alert Charlie to its presence.

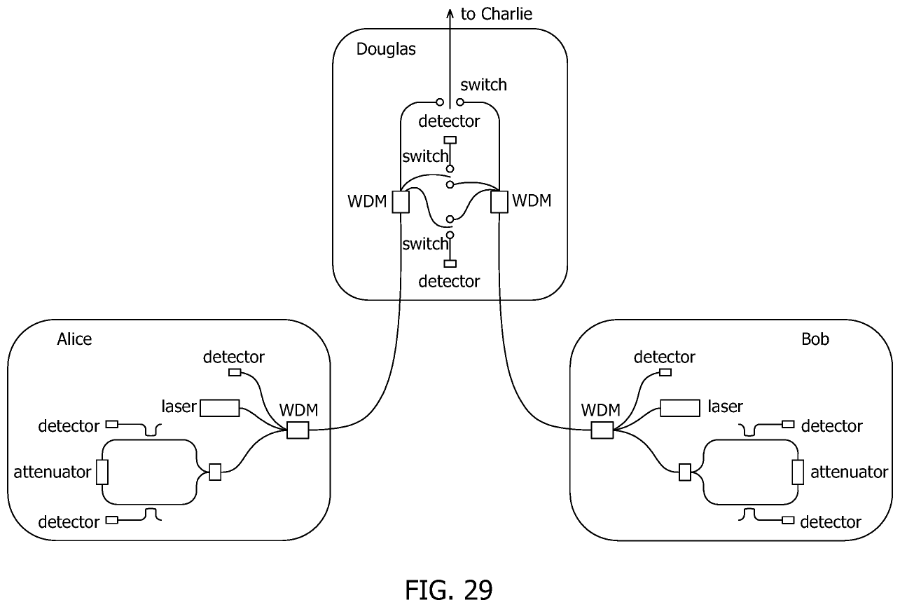

The primary disadvantage of this approach is that neither Alice nor Bob can initiate the communication unless Charlie is continuously sending a CW beam to each of them. In order to eliminate this problem, Alice and Bob will need to have a separate communication source which could be a laser to communicate over the fiber network, or perhaps WiFi to connect to a wireless network. If Alice and Bob incorporate laser sources on their PIC chip, then they could use WDM to communicate with other nodes on a wavelength other than that used for QKD. In that manner, they could potentially be generating a key simultaneously as they are transmitting information. An example is shown in FIG. 29 based on the simple QKD approach in FIG. 22. Although in this example Douglas now separates the wavelengths at his node for more direct communication between Alice and Bob, it is also possible to place the WDMs at Charlie's node if it is desired to keep Douglas' node as simple as possible. In any case, lasers are now located at Alice's and Bob's nodes, which makes their systems more complex. However, because this part of the system involves classical communication, it is not as essential that it be located on the QKD chip and it could instead be a commercially available device such as a SFP transceiver module (C. Gabriel, C. Wittmann, D. Sych, R. Dong, W. Mauerer, U. L. Andersen, C. Marquardt, and G. Leuchs, “A generator for unique quantum random numbers based on vacuum states,” Nat. Photonics 4 (2010) 711-715) combined with a WDM.

FIG. 29 illustrates a technique to enable Alice and Bob to communicate with each other lasers at their locations, perhaps on chip, with wavelength division multiplexing. As shown, Alice can communicate with either Douglas or Bob. However, the WDM can also be located at Charlie instead of Douglas so that Alice and Bob can communicate directly with Charlie if desired. Also, instead of WDMs at Alice and Bob, if they both use the same laser wavelength then separation could be accomplished by circulators. However, presently it is extremely difficult to incorporate circulators on a PIC, so wavelength division is a more suitable approach.

Finally, it should also be mentioned that for short distance QKD communication it may be possible to use shorter wavelength photons. The attenuation with distance through optical fiber is currently quite large for visible light wavelengths precluding long distance communication. However, future development of hollow core fiber looks promising to achieve low loss fiber at essentially any desired wavelength. At visible light wavelengths, Si avalanche photodetectors have high detection efficiency and very low dark counts without the need for cryogenics. In addition, they are much less expensive than superconducting or InGaAs detectors. Therefore, a QKD chip built for shorter wavelengths could have the benefit of reducing hardware costs for Charlie. The main problem is that Si waveguides on PICs are opaque to visible light. SiN waveguides on PICs, on the other hand, are quite transparent. If a PIC QKD chip is fabricated for visible light using SiN waveguides, then the only remaining difficulty is modulating intensity and phase shift of the light pulses. This cannot be done with SiN components, but it is possible using hybrid chips with III-V semiconductors to modulate visible light wavelengths. Steady progress is being made to integrate III-V components with Si chips because it also enables the presence of other active components light laser diodes. Therefore, it is definitely possible that QKD could be accomplished via hybrid PICs and visible light over short distances with current solid core fiber (˜1 km) and over much longer distances in the future with successful development of low loss hollow core fiber.

### 12. Conclusion

In this disclosure we have discussed various QKD techniques and protocols based on polarization or time-binning and phase shifting. In particular, we have discussed and analyzed in detail a new QKD technique that can be completely implemented on a PIC chip for all Alice and Bob edge devices. One big advantage of this approach is that it is based on MDI-QKD, so it is inherently secure from any of the most likely side channel attacks involving the imperfections in single photon detectors. There is still a required Charlie node on the network that involves expensive and large equipment, not implementable on a PIC chip, but this node can be untrusted and by implementing a network design as described in this report, the number of Charlie nodes can be greatly reduced to perhaps one node per central monitoring station. In principle, this approach, like entanglement-based techniques, also extends the QKD communication distance over that achieved by prepare-and-measure QKD techniques (H-K. Lo, M. Curty and B. Qi, “Measurement-device-independent quantum key distribution,” Phys. Rev. Lett. 108 (2012) 130503). We have also argued that a hybrid approach will be necessary for a QKD-protected power grid network. Nodes connected over long distances (>50-100 km) through fiber will most likely require more expensive equipment like cryogenically-cooled SNSPDs which will be larger and have much higher power and maintenance requirements. Shorter distance communication between a station and edge devices can be accomplished with InGaAs SPADs at the Charlie nodes with much lower cost and lower power requirements than SNSPDs. The edge devices, Alice and Bob nodes, can make use of low cost, robust integrated QKD photonic chips.

Various other QKD techniques have also been critically examined. The “reference frame-independent QKD” (rfiQKD) system (http://www.aimphotonics.com/; A Laing, V. Scarani, J. G. Rarity, and J. L. O'Brien, “Reference-frame-independent quantum key distribution,” Phys. Rev. A 82 (2010) 012304) design does not require any light sources or detectors at Bob's node and can in principle be fabricated with current technology. Alice's system is more complex and expensive, but in principle for shorter distances Alice could use much less expensive near IR light source and single photon detectors. By using an attenuated laser for the light source, the “on-demand” issue is relieved. Another advantage is that it follows the BB84 QKD protocol with well-established security proofs using the decoy state for attenuated light sources. The primary disadvantage is that Alice's node cannot be implemented in a PIC chip. Furthermore, Alice and Bob must be connected through two polarization maintaining fibers. Therefore, it is unlikely that an existing fiber network could be employed.

Alternatively, CV-QKD has been developed as a protocol that does not require single photon emitters or single photon detectors. This makes it more amenable to “on-demand” key generation than the entangled photon protocols. More importantly, perhaps, is the fact that homodyne/heterodyne detection systems with germanium detectors have already been demonstrated on-chip. Although security proofs for this protocol are not as complete as for most of the single photon/entangled photon protocols, it may still be an attractive option due to its much lower cost and power requirements for the total system (Alice+Bob). CV-QKD typically requires a high degree of polarization control as well as amplitude and phase modulation. The primary technology gap for this technique is polarization control, which is currently difficult or impossible to adequately integrate on-chip, though the other components for this QKD system can be easily fabricated. Homodyne detection enables lower cost detectors so that communication can be accomplished over longer distances in the telecom band without special cooling requirements. This approach could be used for node-to-node communication if the security proofs are acceptable. Current key generation rates for this design must be greatly improved, however.

Ultimately, an integrated Si photonic chip offers many advantages over larger instrumentation besides just cost and power consumption. Long term stability is greatly improved as alignment and dust are not issues. All components can be directly coupled together on-chip with much higher efficiencies, and operating speeds can be much higher (P. Zhang, et al., “Reference-frame-independent quantum-key-distribution server with a telecom tether for an on-chip client,” Phys. Rev. Lett. 112 (2014) 130501). Integrating the laser source and single photon detectors on-chip cost effectively are big challenges, in addition to polarization control if needed. QKD chips that require components like lasers, SPDs, fiber delay lines, and polarization control may need to use them as off-chip components, and this will eliminate most, if not all, of the cost and size advantages of PIC chips.

As discussed, several technology gaps have been identified with the currently published QKD techniques applied to PIC chips. An on-chip light source is a primary concern. For CV-QKD this would probably require integrating a separate diode laser onto the chip with efficient light coupling into a waveguide. This is currently a research topic and goal for many photonic chip manufacturers and will likely be solved satisfactorily on its own. On-chip photon pair generation has been demonstrated using nonlinear waveguides. Polarization entanglement of the photon pairs is required for many DV-QKD techniques and has been reported by one group, but careful design of the waveguide for TE/TM mode propagation is required. An on-chip, on-demand entangled photon source has yet to be designed and fabricated, which is a large technology gap for several techniques. General-purpose polarization control as well as specialty components like isolators, circulators, and Faraday mirrors are currently difficult or impossible to implement on-chip. If a diode laser is integrated on-chip, for example, then isolators will likely be required. Many of the implemented components require strict temperature control, and the desired temperatures may be incompatible on the same chip. Long time delays now accomplished through tens of meters of fiber cannot be implemented on-chip, another technology gap. While one solution may be to couple light from the chip into an off-board fiber or other component, the optical losses for in- and out-coupling to fiber may be prohibitive. Therefore, the new technique described in this report is a significant advancement in the state-of-the-art and may make QKD cost effective and implementable through industrial control systems, including the power grid.

As will be appreciated by those of skill in the art, the systems and methods described herein may be used in 5G communications systems. For example, quantum key distribution and measurement-device-independent quantum key distribution may be used to protect fiber portions of a 5G network, using the embodiments described herein.

### Acronyms

A/D: anti-diagonal/diagonal (basis)

AM: amplitude modulation

AMZI: asymmetric Mach-Zehnder interferometer

AO: acousto-optic

APD: avalanche photodiode

BB84: Bennett and Brassard QKD protocol from 1984

CV: continuous variable

CW: continuous wave

DFB: distributed fiber Bragg (grating)

DV: discrete variable

EO: electro-optic

H/V: horizontal/vertical (basis)

LN: lithium niobate

LO: local oscillator

MZI: Mach-Zehnder interferometer

MZM: Mach-Zehnder modulator

PBS: polarizing beamsplitter

PC: Pockels cell

PDK: process development kit

PM: polarization maintaining (fiber) or phase modulation

QD: quantum dot

QKD: quantum key distribution

R/L: right-/left-circular polarization (basis)

SFWM: spontaneous four-wave mixing

SM: single mode (fiber)

SNR: signal-to-noise ratio

SNSPD: superconducting nanowire single photon detector

SPAD: single photon avalanche detector

SPD: single photon detector

SPDC: spontaneous parametric down-conversion

TE: transverse electric

TM: transverse magnetic

TSN: time-sensitive network

TS-QKD: time-sensitive QKD

UCSB: University of California, Santa Barbara

VCO: voltage-controlled oscillator

WDM: wavelength division multiplexer

It is to be understood that the above description is intended to be illustrative, and not restrictive. For example, the above-described embodiments (and/or examples thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose several embodiments of the inventive subject matter and also to enable a person of ordinary skill in the art to practice the embodiments of the inventive subject matter, including making and using any devices or systems and performing any incorporated methods. The patentable scope of the inventive subject matter is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general-purpose signal processor, microcontroller, random access memory, hard disk, and the like). Similarly, the programs may be stand-alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

What is claimed is:

1. A photonic integrated circuit comprising:
a waveguide configured to receive photons from an optical fiber and direct the photons in a loop formed by the waveguide; and
one or more of:
a variable optical attenuator coupled with the waveguide and configured to adjust a number of the photons between a key level and one or more decoy levels;
an intensity modulator coupled with the waveguide and configured to adjust a number of the photons between a key level and a decoy level; or
a phase shifter coupled with the waveguide and configured to change a phase of the photons,
wherein the waveguide is configured to direct one or more of the photons back out of the optical fiber after the one or more of the photons has passed through the loop formed by the waveguide with a polarization state of the one or more of the photons rotated by 90°.

2. The photonic integrated circuit of claim 1, further comprising:
a polarizing beamsplitter and polarization rotator configured to be coupled with an optical fiber and to receive photons from the optical fiber, the polarizing beamsplitter and polarization rotator configured to direct incident horizontally polarized photons in one direction in the waveguide and to direct incident vertically polarized photons in an opposite direction in the waveguide.

3. The photonic integrated circuit of claim 1, further comprising:
optical taps coupled with the waveguide and configured to direct a portion of the photons to photodetectors for detection of bright light attacks.

4. The photonic integrated circuit of claim 3, wherein the one or more of the variable optical attenuator, the intensity modulator, or the phase shifter is or are disposed along the waveguide between the optical taps.

5. The photonic integrated circuit of claim 1, wherein the circuit includes the variable optical attenuator.

6. The photonic integrated circuit of claim 1, wherein the circuit includes the intensity modulator.

7. The photonic integrated circuit of claim 1, wherein the circuit includes the phase shifter.

8. The photonic integrated circuit of claim 1, wherein the circuit includes the variable optical attenuator, the intensity modulator, and the phase shifter.

9. The photonic integrated circuit of claim 1, wherein the photonic integrated circuit does not include a Faraday mirror.

10. The photonic integrated circuit of claim 1, further comprising a narrow band optical filter at an entrance of the waveguide.

11. A method of assembly a photonic integrated circuit, the method comprising:
forming a waveguide configured to receive photons from an optical fiber and direct the photons in a loop formed by the waveguide; and
coupling, to the waveguide, one or more of:
a variable optical attenuator configured to adjust a number of the photons between a key level and one or more decoy levels;
an intensity modulator configured to adjust a number of the photons between a key level and a decoy level; or
a phase shifter configured to change a phase of the photons,
wherein the waveguide is configured to direct one or more of the photons back out of the optical fiber after the one or more of the photons has passed through the loop formed by the waveguide with a polarization state of the one or more of the photons rotated by 90°.

12. The method of claim 11, further comprising:
coupling a polarizing beamsplitter and polarization rotator to an optical fiber, the polarizing beamsplitter and polarization rotator configured to receive photons from the optical fiber, the polarizing beamsplitter and polarization rotator further configured to direct incident horizontally polarized photons in one direction in the waveguide and to direct incident vertically polarized photons in an opposite direction in the waveguide.

13. The method of claim 11, further comprising:
coupling optical taps with the waveguide, the optical taps configured to direct a portion of the photons to photodetectors for detection of bright light attacks.

14. The method of claim 13, wherein the one or more of the variable optical attenuator, the intensity modulator, or the phase shifter is or are disposed along the waveguide between the optical taps.

15. The method of claim 11, comprising coupling the variable optical attenuator to the waveguide.

16. The method of claim 11, comprising coupling the intensity modulator to the waveguide.

17. The method of claim 11, comprising coupling the phase shifter to the waveguide.

18. The method of claim 11, comprising coupling the variable optical attenuator, the intensity modulator, and the phase shifter to the waveguide.

19. The method of claim 11, wherein the photonic integrated circuit does not include a Faraday mirror.

20. The method of claim 11, further comprising positioning a narrow band optical filter at an entrance of the waveguide.
